(19) United States
(12) Patent Application Publication
(10) Pub. No.: US 2026/0274086 A1
(43) Pub. Date: Sep. 17, 2026

(54) ELECTRIC WORKING VEHICLE AND REGENERATIVE CHARGING ASSISTANCE SYSTEM

(71) Applicant: Kubota Corporation, Osaka (JP)

(72) Inventor: Shotaro KAWAHATA, Fremont, CA (US)

(21) Appl. No.: 19/425,941

(22) Filed: Dec. 18, 2025

Related U.S. Application Data
(60) Provisional application No. 63/771,720, filed on Mar. 14, 2025.

(51) Int. Cl. B60L 50/60; A01B 71/06; B60L 7/16

(52) U.S. Cl. CPC B60L 50/60; B60L 7/16; A01B 71/063; B60L 2200/40; B60L 2240/421; B60L 2240/486; B60L 2250/16; B60L 2260/26

(57) ABSTRACT

An electric working vehicle includes wheels provided at left and right sides of a traveling vehicle body including a battery, a first motor/generator to drive the wheels using electric power supplied from the battery, a second motor/generator to drive, using electric power supplied from the battery, a power take-off (PTO) shaft for connection with a working device, a motor controller configured or programmed to control driving of the first motor/generator and the second motor/generator, and an input interface to receive input of an instruction to enter a towed regenerative mode in which the traveling vehicle body is towed to rotate the wheels to regeneratively drive the first motor/generator to charge the battery, or a PTO regenerative mode in which the PTO shaft is rotated by external power to regeneratively drive the second motor/generator to charge the battery.

### CROSS-REFERENCE TO RELATED APPLICATIONS

This application claims the benefit of priority to U.S. Provisional Patent Application No. 63/771,720 filed on Mar. 14, 2025. The entire contents of this application are hereby incorporated herein by reference.

### BACKGROUND OF THE INVENTION

### 1. Field of the Invention

The present invention relates to electric working vehicles such as electric tractors each configured to charge a battery by using electric power regeneratively generated by a motor/generator capable of operating as an electric motor or a generator to convert between electrical power and mechanical power, and regenerative charging assistance systems.

### 2. Description of the Related Art

Japanese Unexamined Patent Application Publication No. 2024-033347 discloses an electric tractor with no charger. The electric tractor is configured such that, when the remaining battery charge decreases, the output shaft of an external drive source is connected to the power take-off (PTO) shaft and the PTO clutch is placed in an engaged state, and as power from the external drive source rotates the PTO shaft, electric power can be regeneratively generated by the motor/generator to charge the battery.

### SUMMARY OF THE INVENTION

Although the electric tractor in Japanese Unexamined Patent Application Publication No. 2024-033347 is configured to support regenerative charging using an external drive source connected to the PTO shaft (i.e., PTO regenerative charging), it is impossible or difficult to perform a different type of regenerative charging using a different tractor. The electric tractor in Japanese Unexamined Patent Application Publication No. 2024-033347 is thus not configured to flexibly support a plurality of types of regenerative charging.

Example embodiments of the present invention provide electric working vehicles each configured to flexibly support a plurality of types of regenerative charging.

An electric working vehicle according to an example embodiment of the present invention includes a battery, a traveling vehicle body including the battery, wheels provided at left and right sides of the traveling vehicle body, a first motor/generator to drive the wheels using electric power supplied from the battery, a second motor/generator to drive, using electric power supplied from the battery, a power take-off (PTO) shaft for connection with a working device, a motor controller configured or programmed to control driving of the first motor/generator and the second motor/generator, and an input interface to receive input of an instruction to enter a regenerative mode in which at least one of the first motor/generator or the second motor/generator is driven regeneratively to charge the battery, wherein the regenerative mode includes a towed regenerative mode in which the traveling vehicle body is towed to rotate the wheels to regeneratively drive the first motor/generator, and a PTO regenerative mode in which the PTO shaft is rotated by external power to regeneratively drive the second motor/generator, and the input interface is configured to receive input of the instruction to enter the towed regenerative mode or the PTO regenerative mode.

The regenerative mode may further include a towed and PTO regenerative mode in which the electric working vehicle operates concurrently in both the towed regenerative mode and the PTO regenerative mode.

The motor controller may be configured or programmed to, when the electric working vehicle is in the towed regenerative mode, control the driving of the first motor/generator and the second motor/generator such that the first motor/generator is driven regeneratively and the second motor/generator is stopped, and, when the electric working vehicle is in the PTO regenerative mode, control the driving of the first motor/generator and the second motor/generator such that the first motor/generator is stopped and the second motor/generator is driven regeneratively.

The motor controller may be configured or programmed to, when the electric working vehicle is in the towed and PTO regenerative mode, control the driving of the first motor/generator and the second motor/generator such that the first motor/generator and the second motor/generator are driven regeneratively.

The electric working vehicle may further include a notifier configured or programmed to, upon receipt by the input interface of input of the instruction to enter the regenerative mode, provide a user with a notification prompting the user to change states of a travel operation actuator and a working device operation actuator to specified states based on the regenerative mode for which the instruction is received.

The electric working vehicle may further include a parking brake. The travel operation actuator includes a forward and rearward switching operation actuator including a forward-travel position, a rearward-travel position, and a neutral position and configured to be operated to switch a direction of travel of the traveling vehicle body. The working device operation actuator may include a PTO switch. The notifier may be configured or programmed to, when the regenerative mode is the towed regenerative mode, provide the notification to prompt the user to bring the forward and rearward switching operation actuator into the forward-travel position, turn off the parking brake, and turn off the PTO switch.

The electric working vehicle may further include a parking brake. The travel operation actuator may include a forward and rearward switching operation actuator including a forward-travel position, a rearward-travel position, and a neutral position and configured to be operated to switch a direction of travel of the traveling vehicle body. The working device operation actuator may include a PTO switch. The notifier may be configured or programmed to, when the regenerative mode is the PTO regenerative mode, provide the notification to prompt the user to bring the forward and rearward switching operation actuator into the neutral position, turn on the parking brake, and turn on the PTO switch.

The electric working vehicle may further include a parking brake, and a notifier configured or programmed to, upon receipt by the input interface of input of the instruction to enter the regenerative mode, provide a user with a notification to prompt the user to change states of a travel operation actuator and a working device operation actuator to specified states based on the regenerative mode for which the instruction is received. The travel operation actuator may include a forward and rearward switching operation actuator including a forward-travel position, a rearward-travel position, and a neutral position and configured to be operated to switch a direction of travel of the traveling vehicle body. The working device operation actuator may include a PTO switch. The notifier may be configured or programmed to, when the regenerative mode is the towed and PTO regenerative mode, provide the notification to prompt the user to bring the forward and rearward switching operation actuator into the rearward-travel position, turn off the parking brake, and turn on the PTO switch.

The electric working vehicle may further include a travel operation actuator, a working device operation actuator, and a parking brake. The travel operation actuator may include a forward and rearward switching operation actuator including a forward-travel position, a rearward-travel position, and a neutral position and configured to be operated to switch a direction of travel of the traveling vehicle body. The working device operation actuator may include a PTO switch. The motor controller may be configured or programmed to, upon receipt by the input interface of input of the instruction to enter the towed regenerative mode, determine that a regeneration start condition is satisfied when the forward and rearward switching operation actuator is in the forward-travel position, the parking brake is off, and the PTO switch is off, and control the driving of the first motor/generator and the second motor/generator such that the first motor/generator is driven regeneratively and the second motor/generator is stopped.

The electric working vehicle may further include a travel operation actuator, a working device operation actuator, and a parking brake. The travel operation actuator may include a forward and rearward switching operation actuator including a forward-travel position, a rearward-travel position, and a neutral position and configured to be operated to switch a direction of travel of the traveling vehicle body. The working device operation actuator may include a PTO switch. The motor controller may be configured or programmed to, upon receipt by the input interface of input of the instruction to enter the PTO regenerative mode, determine that a regeneration start condition is satisfied when the forward and rearward switching operation actuator is in the neutral position, the parking brake is on, and the PTO switch is on, and control the driving of the first motor/generator and the second motor/generator such that the first motor/generator is stopped and the second motor/generator is driven regeneratively.

The electric working vehicle may further include a travel operation actuator, a working device operation actuator, and a parking brake. The travel operation actuator may include a forward and rearward switching operation actuator including a forward-travel position, a rearward-travel position, and a neutral position and configured to be operated to switch a direction of travel of the traveling vehicle body. The working device operation actuator may include a PTO switch. The motor controller may be configured or programmed to, upon receipt by the input interface of input of the instruction to enter the towed and PTO regenerative mode, determine that a regeneration start condition is satisfied when the forward and rearward switching operation actuator is in the rearward-travel position, the parking brake is off, and the PTO switch is on, and control the driving of the first motor/generator and the second motor/generator such that the first motor/generator and the second motor/generator are driven regeneratively.

The electric working vehicle may further include a transmission to change speed stages to change a propelling force for the traveling vehicle body, the transmission being configured to switch at least between a first speed stage including a first speed and a second speed stage including a second speed which is greater than the first speed, and a transmission controller configured or programmed to control the transmission. The transmission controller may be configured or programmed to bring the transmission into the first speed stage when the electric working vehicle is in the towed regenerative mode.

The electric working vehicle may further include a transmission to change speed stages to change a propelling force for the traveling vehicle body, the transmission being configured to switch at least between a first speed stage including a first speed and a second speed stage including a second speed which is greater than the first speed, and a transmission controller configured or programmed to control the transmission. The transmission controller may be configured or programmed to bring the transmission into the first speed stage when the electric working vehicle is in the towed and PTO regenerative mode.

A regenerative charging assistance system according to an example embodiment of the present invention includes the electric working vehicle, and another vehicle including an output shaft to couple the PTO shaft thereto and configured to tow the electric working vehicle, wherein the towed regenerative mode is a regenerative mode in which the another vehicle tows the traveling vehicle body to rotate the wheels to regeneratively drive the first motor/generator, and the PTO regenerative mode is a regenerative mode in which, when the PTO shaft is in connection with the output shaft of the another vehicle, power from the output shaft rotates the PTO shaft to regeneratively drive the second motor/generator.

The above and other elements, features, steps, characteristics and advantages of the present invention will become more apparent from the following detailed description of the example embodiments with reference to the attached drawings.

### BRIEF DESCRIPTION OF THE DRAWINGS

A more complete appreciation of example embodiments of the present invention and many of the attendant advantages thereof will be readily obtained as the same becomes better understood by reference to the following detailed description when considered in connection with the accompanying drawings described below.

FIG. 1 is a block diagram illustrating a configuration of an electric working vehicle.

FIG. 2 illustrates an example of devices and equipment related to traveling performed by a traveling device.

FIG. 3 is a schematic side view of an example of the electric working vehicle.

FIG. 4 is a schematic plan view of an example of the electric working vehicle.

FIG. 5 illustrates the vicinity of an operator's seat.

FIG. 6 is a perspective view of a lifter as seen from the rear.

FIG. 7 illustrates a controller of the electric working vehicle, its associated devices, and the like.

FIG. 8 illustrates a control of first motor/generators and a brake mechanism performed by the controller.

FIG. 9 illustrates three regenerative modes.

FIG. 10A illustrates an example of a selection screen to select a regenerative mode.

FIG. 10B illustrates a notification screen for a towed regenerative mode.

FIG. 10C illustrates a notification screen for a PTO regenerative mode.

FIG. 10D illustrates a notification screen for a towed and PTO regenerative mode.

FIG. 11A is a flowchart illustrating an example of a control process performed by the controller to control regenerative charging.

FIG. 11B is a flowchart illustrating another example of a control process performed by the controller to control regenerative charging.

FIG. 12 provides, for various regenerative modes of the electric working vehicle, descriptions of controls, descriptions of notifications, and descriptions of the settings for another vehicle.

FIG. 13 is a flowchart illustrating an example of a control process for another vehicle.

### DETAILED DESCRIPTION OF THE EXAMPLE EMBODIMENTS

Example embodiments will now be described with reference to the accompanying drawings, wherein like reference numerals designate corresponding or identical elements throughout the various drawings. The drawings are to be viewed in an orientation in which the reference numerals are viewed correctly.

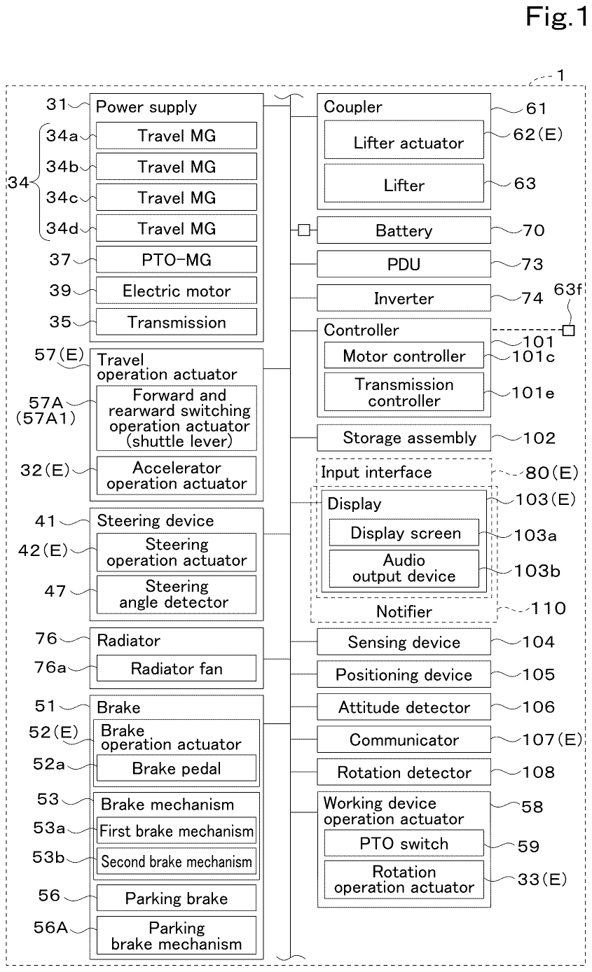

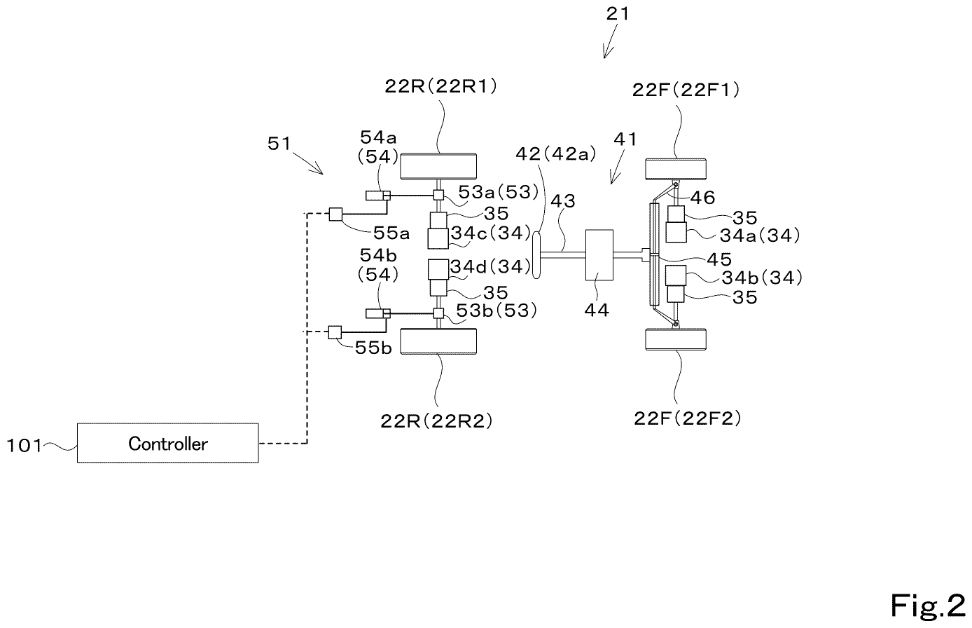

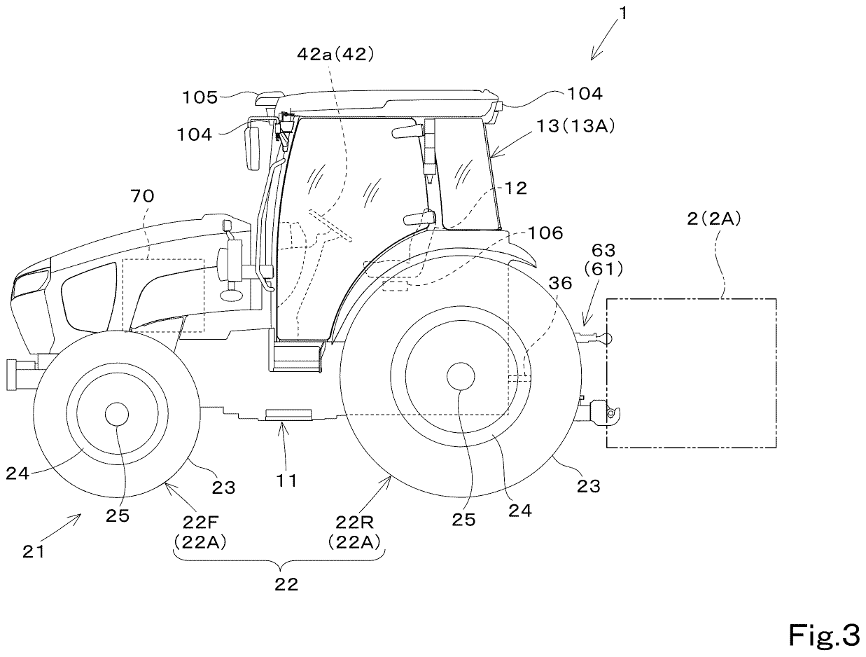

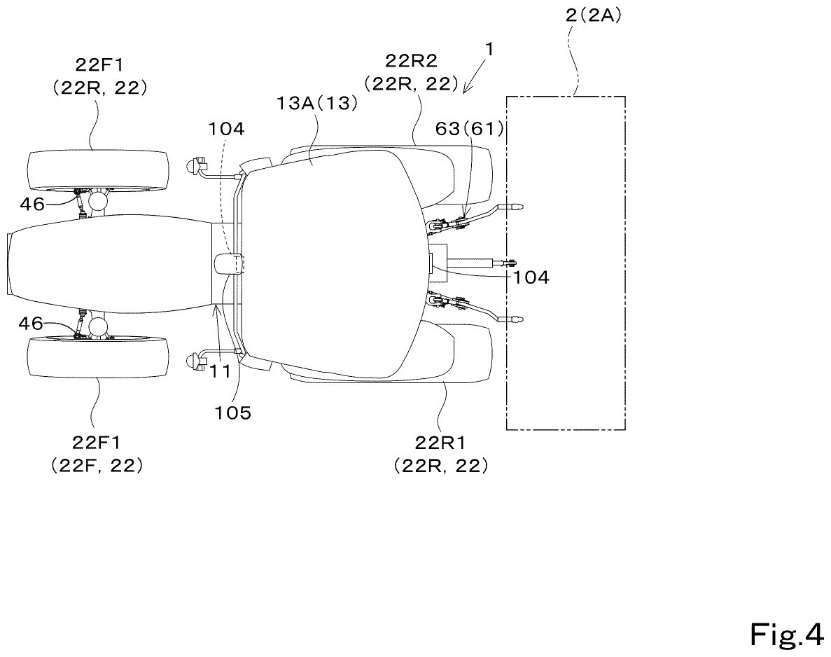

Example embodiments of the present invention will now be described with reference to the drawings. FIG. 1 is a block diagram illustrating a configuration of an electric working vehicle 1. FIG. 2 illustrates an example of devices and equipment related to traveling performed by a traveling device 21. FIG. 3 is a schematic side view of an example of the electric working vehicle 1. FIG. 4 is a schematic plan view of an example of the electric working vehicle 1. The electric working vehicle 1 is a vehicle configured to travel via the traveling device 21. The electric working vehicle 1 according to the present example embodiment is an electric tractor with a traveling vehicle body 11 (a machine body) to attach a working device 2 (an implement) thereto. The following description is directed to the electric working vehicle 1 to be operated manually through a manual operation performed by a user (e.g., an operator) seated on an operator's seat 12.

The electric working vehicle 1 may be operated by automatic control that does not rely on operator's manual operation, or by remote control based on remote operation via a remote manual operator. The electric working vehicle 1 is not limited to an electric tractor but may be any vehicle that is configured to travel via the traveling device 21, and that allows the working device 2 to be detachably attached thereto. For example, the electric working vehicle 1 may be an electric construction machine to detachably attach a working device (an attachment) thereto, such as a compact track loader or a backhoe.

In the following description, the direction (the left-hand side of FIGS. 3 and 4) in which the operator seated on the operator's seat 12 of the electric working vehicle 1 faces is referred to as front or forward, and the direction (the right-hand side of FIGS. 3 and 4) opposite to this direction is referred to as rear or rearward. The direction leftward of the operator (the near side of FIG. 3, the lower side of FIG. 4) is referred to as left or leftward, and the direction rightward of the operator (the far side of FIG. 3, the upper side of FIG. 4) is referred to as right or rightward. The horizontal direction, which is the direction orthogonal to the front-rear direction, is referred to as width direction. The direction orthogonal to the horizontal direction is referred to as vertical direction.

As illustrated in FIGS. 3 and 4, the electric working vehicle 1 includes the traveling vehicle body 11, and the traveling device 21. The traveling vehicle body 11 supports various devices and equipment included in the electric working vehicle 1. For example, the traveling vehicle body 11 includes the operator's seat 12, and a protective structure 13 configured to protect the operator's seat 12. The protective structure 13 is, for example, a cabin 13A surrounding the operator's seat 12. The protective structure 13 is not limited to the cabin 13A but may be a canopy, or a ROPS or other such structure erected at the rear of the operator's seat 12.

The traveling device 21 supports the traveling vehicle body 11 such that the traveling vehicle body 11 is allowed to travel. The traveling device 21 is configured to be driven to provide propelling force to the traveling vehicle body 11. The traveling device 21 includes one or more wheels 22 to be rotated by the power supplied from a power supply 31. According to the present example embodiment, the traveling device 21 includes a plurality of wheels 22. The wheels 22 are arranged in spaced relation in the front-rear direction or the width direction. The traveling device 21 includes a pair of front wheels 22F to support a front portion of the traveling vehicle body 11, and a pair of rear wheels 22R to support a rear portion of the traveling vehicle body 11. Although the rear wheels 22R have a greater outer diameter than the front wheels 22F in the example in FIGS. 3 and 4, the rear wheels 22R may have substantially the same outer diameter as the front wheels 22F.

Specifically, the front wheel 22F at the left side (i.e., a left front wheel 22F1), and the front wheel 22F at the right side (i.e., a right front wheel 22F2) are arranged in spaced relation in the width direction of the traveling vehicle body 11. The rear wheel 22R at the left side (i.e., a left rear wheel 22R1), and the rear wheel 22R at the right side (i.e., a right rear wheel 22R2) are arranged in spaced relation in the width direction of the traveling vehicle body 11. The left front wheel 22F1 and the left rear wheel 22R1 are arranged in spaced relation in the front-rear direction of the traveling vehicle body 11. The right front wheel 22F2 and the right rear wheel 22R2 are arranged in spaced relation in the front-rear direction of the traveling vehicle body 11.

In the example in FIGS. 3 and 4, the wheels 22 of the traveling device 21 are tire-equipped wheels 22 each including a tire 23. Each tire-equipped wheel 22 includes an annular rim 24 with the tire 23 fit on its outer periphery, and a hub 25 that is located in the central portion of the tire 23 and that allows the rim 24 to be mounted to the axle. The wheels 22 are not limited to tire-equipped wheels 22 but may be crawler-type wheels (track-type wheels).

The power supply 31 is configured to supply power to the traveling device 21. As illustrated in FIG. 1, the power supply 31 includes, for example, one or more first motor/generators 34 (travel motor/generators used for traveling). The power supply 31 is configured to drive the traveling device 21 by using power (rotational driving force) generated by the one or more first motor/generators 34. That is, the electric working vehicle 1 is an electric working vehicle to be driven by the first motor/generator 34. The first motor/generator 34 is an interior permanent magnet alternating-current (AC) synchronous motor, a wound-field synchronous motor, or the like, which is capable of operating as an electric motor or a generator to convert between electrical power and mechanical power. The first motor/generator 34 is driven by electric power supplied from a battery 70 (a main battery) provided to the traveling vehicle body 11.

The battery 70 is rechargeable. For example, the battery 70 is a secondary battery such as a lithium ion battery or a lead-acid battery. The battery 70 includes therein a plurality of cells that are electrically connected in series and in parallel. A power distribution unit (PDU) 73 and a plurality of (six in this example) inverters 74 are provided in an electric power supply path that connects the battery 70 and the first motor/generators 34. The PDU 73 distributes the electric power from the battery 70, and supplies the resulting electric power to four inverters 74 used for the first motor/generators 34. Each of the four inverters 74 is a device to drive the corresponding first motor/generator 34, and configured to convert direct-current (DC) electric power into three-phase AC electric power and supply the three-phase AC electric power to the first motor/generator 34. The inverter 74 is configured to change, as desired, the current and voltage of the electric power to be supplied to the first motor/generator 34.

According to the present example embodiment, the power supply 31 includes a plurality of first motor/generators 34 each configured to supply power to the corresponding one of the wheels 22 of the traveling device 21. In other words, the power supply 31 includes four first motor/generators 34 corresponding one-to-one to the four wheels 22, and drives each of the wheels 22 independently via the corresponding first motor/generator 34. That is, the four first motor/generators 34 include travel motor/generators (MGs) 34a to 34d. The travel MG 34a drives the left front wheel 22F1. The travel MG 34b drives the right front wheel 22F2. The travel MG 34c drives the left rear wheel 22R1. The travel MG 34d drives the right rear wheel 22R2. The travel MGs 34a to 34d are configured to rotate in forward and reverse directions.

The power supply 31 may supply power to a device other than the traveling device 21. According to the present example embodiment, the power supply 31 includes a second motor/generator 37 and an electric motor 39, in addition to the first motor/generators 34 configured to drive the traveling device 21.

The second motor/generator 37 drives, by using electric power supplied from the battery 70, a PTO shaft 36 configured to supply power to the working device 2. According to the present example embodiment, the PTO shaft 36 projects rearward from a rear portion of the traveling vehicle body 11. The PTO shaft 36 may project forward from a front portion of the traveling vehicle body 11. The PTO shaft 36 is provided to at least one of the front and rear portions of the traveling vehicle body 11.

The electric motor 39 drives, by using electric power supplied from the battery 70, a hydraulic pump 38 configured to actuate hydraulic equipment provided to the electric working vehicle 1.

Although the electric working vehicle 1 will be described below with reference, by way of example, to the case where the power supply 31 includes a plurality of first motor/generators 34 each configured to supply power to the corresponding one of the wheels 22, the power supply 31 may include a common first motor/generator 34 configured to supply power to the wheels 22. In such a case, the wheels 22 are driven by the power supplied from the common first motor/generator 34. The first motor/generator 34 may supply power to other devices (such as the PTO shaft 36 and the hydraulic pump 38), in addition to the wheels 22. The number of first motor/generators 34 included in the power supply 31, and power recipients (such as the wheels 22 or the PTO shaft 36) to which the power supply 31 supplies power are not limited to those in the example mentioned above.

The output shaft of each first motor/generator 34 is directly or indirectly connected to the input shaft of the corresponding power recipient, and transmits generated power to the power recipient. The output shaft of the first motor/generator 34 is indirectly connected to the input shaft of the power recipient via, for example, a transmission 35 including a plurality of gears.

The transmission 35 is configured to change speed gears to change the propelling force for the traveling device 21 and the traveling speed of the traveling device 21. The transmission 35 is configured to change speed stages to change the propelling force for the traveling vehicle body 11. The transmission 35 is configured to, based on the operation of a shift lever, switch at least between a first speed stage including a first speed and a second speed stage including a second speed which is greater than the first speed. For example, the transmission 35 is configured to, when the shift lever is in an operating position corresponding to the first speed stage, change speeds within the first speed stage in accordance with the amount of operation of an accelerator operation actuator 32 and, when the shift lever is in an operating position corresponding to the second speed stage, change speeds within the second speed stage in accordance with the amount of operation of the accelerator operation actuator 32. The transmission 35 may be configured to switch at least between the first speed stage, the second speed stage, and a third speed stage including a third speed which is greater than the second speed, or may be configured to switch between four or more speed stages. The transmission 35 may be either a continuously variable transmission or a stepped transmission. The transmission 35 includes a clutch configured to switch between an engaged state in which power from each first motor/generator 34 is transmitted to the corresponding wheel 22, and a disengaged state in which the power is not transmitted to the corresponding wheel 22. The disengaged state is also referred to as a cut-off state in which the transmission of power to the wheel 22 is cut off.

As illustrated in FIGS. 1 and 2, the electric working vehicle 1 includes a steering device 41. The steering device 41 is a device to change the steering direction and steering angle (turning angle) of the electric working vehicle 1. The steering device 41 includes a steering operation actuator 42, a steering shaft 43, a steering control valve 44, a steering cylinder 45, an arm 46 (knuckle arm), and a steering angle detector 47.

The steering operation actuator 42 includes a steering wheel 42a. The steering wheel 42a is provided in the vicinity of the operator's seat 12, and operated by an operator seated on the operator's seat 12.

The steering shaft 43 is a rotary shaft to support the steering wheel 42a such that the steering wheel 42a is rotatable.

The steering control valve 44 receives supply of hydraulic fluid delivered by the hydraulic pump 38, and regulates the flow of hydraulic fluid to the steering cylinder 45. The steering control valve 44 is, for example, a three-position switching valve that can be switched between positions by movement of a spool or the like. The steering control valve 44 can be switched in accordance with the steering direction (rotation direction) of the steering shaft 43.

The steering cylinder 45 is driven by hydraulic fluid supplied from the steering control valve 44. The steering cylinder 45 is configured to, when the position and opening of the steering control valve 44 are switched, extend or retract in one widthwise direction or the other widthwise direction depending on the switched position and opening of the steering control valve 44.

The arm 46 is connected to the steering cylinder 45. The arm 46 moves in response to the extension or retraction of the steering cylinder 45 to thus change the steering (steering direction and turning angle) of the front wheels 22F.

The steering angle detector 47 detects a steering operation (steering direction and turning angle) performed via the steering operation actuator 42, and outputs a detection signal indicating a steering operation value to a controller 101. The steering angle detector 47 is, for example, a steering angle sensor such as a rotary encoder.

The configuration of the steering device 41 described above is illustrative, and not limited to the above configuration. For example, in a case where, as with the present example embodiment, each first motor/generator 34 is driven independently such that the propelling force is made to differ in magnitude between one side and the other side in the width direction of the traveling device 21 to enable changing of the turning angle, the traveling device 21 may be configured to also function as part of the steering device 41. In such a case, the power supply 31 is configured to, in accordance with the rotation angle of the steering wheel 42a (the steering shaft 43), change the driving force of the first motor/generator 34 to make the propelling force differ in magnitude between one side and the other side in the width direction and thus change the turning angle.

As illustrated in FIGS. 1 and 2, the electric working vehicle 1 includes a brake 51. The brake 51 is configured to brake the traveling device 21. According to the present example embodiment, the brake 51 is configured to brake the left rear wheel 22R1 and the right rear wheel 22R2. The brake 51 includes a brake operation actuator 52, and a brake mechanism 53.

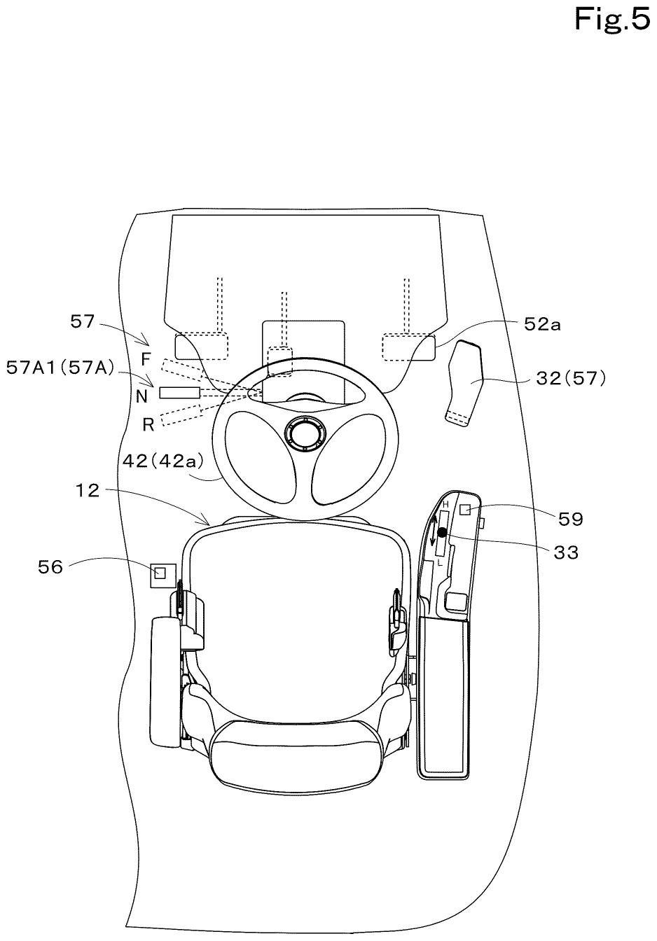

FIG. 5 illustrates the vicinity of the operator's seat 12. As illustrated in FIG. 5, the brake operation actuator 52 is provided in the vicinity of the operator's seat 12, and operated by an operator seated on the operator's seat 12. Examples of the brake operation actuator 52 may include operation actuators such as a pedal (foot pedal), a lever, a button, a switch, and a dial. According to the present example embodiment, the brake operation actuator 52 is a single brake pedal 52a to control braking of the left rear wheel 22R1 and the right rear wheel 22R2. That is, the left rear wheel 22R1 and the right rear wheel 22R2 are braked simultaneously through operation of a single brake pedal 52a.

The brake mechanism 53 is, for example, a disc-type hydraulic brake. The brake mechanism 53 includes a first brake mechanism 53a configured to brake the left rear wheel 22R1, and a second brake mechanism 53b configured to brake the right rear wheel 22R2. The first brake mechanism 53a is provided to the axle of the left rear wheel 22R1. The second brake mechanism 53b is provided to the axle of the right rear wheel 22R2.

When a pressing operation of the brake pedal 52a (e.g., an operation of pressing the brake pedal 52a from a released position toward a braking position) is performed, then in accordance with the amount of the operation performed, the first brake mechanism 53a increases the braking force on the left rear wheel 22R1, and the second brake mechanism 53b increases the braking force on the right rear wheel 22R2. When a return operation of the brake pedal 52a (e.g., an operation of returning the brake pedal 52a from the braking position toward the released position) is performed, then in accordance with the amount of the operation performed, the first brake mechanism 53a reduces the braking force on the left rear wheel 22R1, and the second brake mechanism 53b reduces the braking force on the right rear wheel 22R2.

As illustrated in FIG. 1, the electric working vehicle 1 includes a parking brake 56 (e.g., a parking brake switch) to be operated by the operator, and a parking brake mechanism 56A. The parking brake mechanism 56A includes a lock configured to, based on an ON operation of the parking brake 56, engage with a gear on a rear axle to disable rotation of the rear axle, and an actuator configured to actuate the lock. As illustrated in FIG. 5, the parking brake 56 is provided in the vicinity of the operator's seat 12, and operated by the operator seated on the operator's seat 12. When the parking brake 56 is operated from OFF (released position) to ON (braking position), the parking brake mechanism 56A causes the actuator to perform a first action (locking action) to engage the lock with a gear on the rear axle connected to the rear wheel 22R and thus disable rotation of (i.e., lock) the rear wheels 22R. When the parking brake 56 is operated from ON (braking position) to OFF (released position), the parking brake mechanism 56A causes the actuator to perform a second action (unlocking action) to disengage the lock from the gear on the rear axle and thus enable rotation of (i.e., unlock) the rear wheels 22R. The parking brake mechanism 56A may be configured to be actuated not only when the parking brake 56 is operated by the operator but also automatically via the brake 51.

The brake 51 is not limited to the example mentioned above but may be configured to brake the left front wheel 22F1 and the right front wheel 22F2, in addition to or instead of the left rear wheel 22R1 and the right rear wheel 22R2.

As illustrated in FIGS. 1 and 3, the electric working vehicle 1 includes a coupler 61. As illustrated in FIGS. 3 and 4, the coupler 61 allows coupling of the working device 2 to the traveling vehicle body 11. The working device 2 is configured to be detachably attached to the coupler 61. The coupler 61 is provided at a rear portion of the traveling vehicle body 11 to allow coupling of the working device 2 to the traveling vehicle body 11.

The coupler 61 includes, for example, a lifter 63 to support the working device 2 such that the working device 2 can be raised or lowered. The lifter 63 raises or lowers the working device 2 relative to the traveling vehicle body 11 such that the positions of the traveling vehicle body 11 and the working device 2 can be changed relative to each other. The lifter 63 allows coupling of the working device 2 thereto. FIGS. 3 and 4 illustrate an example where the lifter 63 is provided at a rear portion of the traveling vehicle body 11.

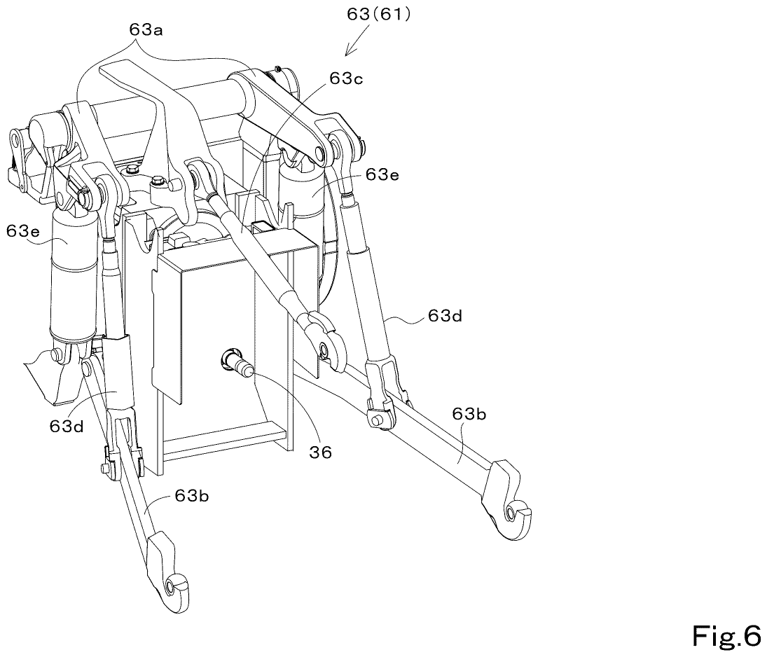

FIG. 6 is a perspective view of the lifter 63 as seen from the rear. The lifter 63 includes a lift arm 63a, a lower link 63b, a top link 63c, a lift rod 63d, and a lift cylinder 63e.

The front end portion of the lift arm 63a is supported on an upper rear portion of the traveling vehicle body 11 such that the front end portion of the lift arm 63a is allowed to swing upward or downward. The lift arm 63a swings (is raised or lowered) as the lift cylinder 63e is driven. The lift cylinder 63e is a hydraulic cylinder. The lift cylinder 63e is connected to the hydraulic pump 38 via a raising and lowering control valve 63f. The raising and lowering control valve 63f is a solenoid valve or the like. The raising and lowering control valve 63f is configured to cause the lift cylinder 63e to extend or retract by changing either the hydraulic fluid that is to be supplied from the hydraulic pump 38 to the lift cylinder 63e or the hydraulic fluid that is to be discharged from the lift cylinder 63e.

The front end portion of the lower link 63b is supported on a lower rear portion of the traveling vehicle body 11 such that the front end portion of the lower link 63b is allowed to swing upward or downward. At a position above the lower link 63b, the front end portion of the top link 63c is supported on a rear portion of the traveling vehicle body 11 such that the front end portion of the top link 63c is allowed to swing upward or downward. The lift rod 63d couples the lift arm 63a and the lower link 63b to each other. A rear portion of the lower link 63b, and a rear portion of the top link 63c have a hooked shape.

As the lift cylinder 63e is driven (extended or retracted), the lift arm 63a is raised or lowered, and the lower link 63b coupled to the lift arm 63a via the lift rod 63d is raised or lowered. This allows the working device 2 to swing upward or downward (to be raised or lowered) about a front portion of the lower link 63b.

The working device 2 is a device coupled to the traveling vehicle body 11 via the coupler 61 to perform work. Examples of the working device 2 include a cultivator for cultivation, a ridger for ridging, a furrow opener for opening furrows, a harvester for harvesting crops, a mower for mowing forage grass or the like, a tedder for tedding forage grass or the like, a rake for raking forage grass or the like, a baler for baling forage grass or the like, a fertilizer spreader for spreading fertilizer, an agricultural chemical spreader for spreading agricultural chemicals, a separator for separating crops, and a carrier on which materials or the like can be loaded.

Devices, equipment, and the like installed in the electric working vehicle 1 will now be described in detail with reference mainly to FIG. 1. As illustrated in FIG. 1, the electric working vehicle 1 includes the controller 101. The electric working vehicle 1 also includes a storage assembly (memory and/or storage) 102.

The controller 101 includes one or more processors. The controller 101 may be a controller for the electric working vehicle 1, and may be configured or programmed to perform various controls related to the electric working vehicle 1. The controller 101 may be, for example, a vehicle control unit (VCU). The controller 101 is communicably connected via an in-vehicle network such as CAN, ISOBUS, LIN, or FlexRay to various devices or equipment installed in the electric working vehicle 1. The controller 101 is configured or programmed to, via the in-vehicle network, acquire the states of various devices and various equipment. For example, the controller 101 is configured or programmed to, via the in-vehicle network, acquire information such as information indicating the attachment state of the working device 2 (whether the working device 2 is attached) or information indicating the type (such as direct-attach type or tow type) of the working device 2. The controller 101 may be configured or programmed to acquire such information input via an input interface 80 described later.

The controller 101 includes one or more memories, various analog circuits, various digital circuits, and the like. The one or more memories store a software program to be executed by the one or more processors, and various data. The controller 101 may be configured or programmed to, via the one or more processors, read the software program from the one or more memories, and execute various processing based on the software program. The controller 101 may be configured or programmed to, via the one or more processors, execute various processing based on a predetermined logic circuit.

Examples of such a processor include a central processing unit (CPU), a graphics processing unit (GPU), a digital signal processor (DSP), a field programmable gate array (FPGA), and an application specific integrated circuit (ASIC).

The controller 101 may be configured or programmed to execute various processing via a plurality of physically separate processors cooperating with each other. That is, the controller 101 need not necessarily be configured or programmed as described above. In such a case, each of the processors is installed in the corresponding one of one or more computers that are physically separate from the electric working vehicle 1, and these processors are communicably connected via a network such as an in-vehicle network, a LAN, a WAN, or the Internet.

A configuration may be used in which the software program is stored in the storage assembly 102 communicably connected to the controller 101, or in an external server connected via the above-mentioned network, and is installed into the above-mentioned memory from the above-mentioned storage assembly or server.

The storage assembly 102 is a device configured to store information. The storage assembly 102 is a nonvolatile memory such as a hard disk drive (HDD) or a solid state drive (SSD). The storage assembly 102 is communicably connected with the controller 101. The controller 101 causes various information to be stored into the storage assembly 102, or acquires information stored in the storage assembly 102.

As illustrated in FIG. 1, the electric working vehicle 1 includes a notifier 110. The notifier 110 includes, for example, a display 103. The display 103 includes, for example, a display screen 103a such as a liquid crystal display. The display 103 is controlled by the controller 101 to display various information related to the electric working vehicle 1. The display 103 is located in the vicinity of the operator's seat 12. The display screen 103a of the display 103 may be provided with a touchscreen.

The notifier 110 may include an audio output device 103b instead of or in addition to the display 103. The audio output device 103b is a device configured to output notification-related audio. The audio output device 103b is, for example, a speaker of the display 103.

As illustrated in FIG. 1, the electric working vehicle 1 may include a sensing device 104 to detect the surrounding environment. The sensing device 104 is connected to the controller 101 such that the sensing device 104 is capable of wired or wireless communication with the controller 101. The sensing device 104 outputs sensing results to the controller 101. The controller 101 is configured or programmed to detect an obstacle in the surrounding area of the electric working vehicle 1 based on the sensing results obtained from the sensing device 104, or estimate the position of the electric working vehicle 1 based on the sensing results (detected point cloud data) and based on environmental map information stored in the storage assembly 102 or the like. Hereinafter, the position of the electric working vehicle 1 estimated based on the sensing results will be sometimes referred to as estimated position.

The sensing device 104 includes an optical range sensor, a signal processing circuit, and the like. An example of the optical range sensor of the sensing device 104 may be a light detection and ranging (LiDAR) sensor.

A LiDAR sensor (laser sensor) emits pulsed measuring light (laser beam) from a light source such as a laser diode millions of times per second, and scans a predetermined detection range (a sensing range of, for example, 360 degrees) in the horizontal or vertical direction by causing the measuring light to reflect off a rotating mirror onto the detection range. The LiDAR sensor then receives, via a photodetector, light reflected from a target object. The signal processing circuit measures the distance to the target object based on the time taken until the reflection of the measuring beam emitted by the LiDAR sensor is received (time of flight (ToF) method).

Examples of the optical range sensor of the sensing device 104 other than a LiDAR sensor may include an imager such as a charge coupled device (CCD) camera incorporating a CCD image sensor or a complementary metal oxide semiconductor (CMOS) camera incorporating a CMOS image sensor, and a ToF camera. Although the above example is directed to the case where the sensing device 104 includes an optical range sensor, an acoustic range sensor (e.g., a sonar or other airborne ultrasonic acoustic sensor) may be used instead of an optical range sensor.

As illustrated in FIG. 1, the electric working vehicle 1 may include a positioning device 105. The positioning device 105 is a device configured to measure the position of the electric working vehicle 1 (detect the position of the electric working vehicle 1). The positioning device 105 is communicably connected with the controller 101, and outputs the measured position of the electric working vehicle 1 to the controller 101. The positioning device 105 receives a satellite signal from a satellite positioning system via a GPS antenna, and measures the position of the electric working vehicle 1 based on the satellite signal. The positioning device 105 performs, as positioning of the electric working vehicle 1, measurement of a predetermined position of the electric working vehicle 1. Hereinafter, the position of the electric working vehicle 1 measured by the positioning device 105 will be sometimes referred to as measured position. The positioning device 105 may detect, in addition to the measured position, the orientation of the electric working vehicle 1 (e.g., the orientation of a front portion of the traveling vehicle body 11 or the orientation of the vehicle body).

As illustrated in FIG. 1, the electric working vehicle 1 may include an attitude detector 106. The attitude detector 106 is a device to detect the attitude of the electric working vehicle 1 (the traveling vehicle body 11). The attitude detector 106 is communicably connected with the controller 101, and outputs the detected attitude of the traveling vehicle body 11 to the controller 101. Specifically, the attitude detector 106 detects three-dimensional inertial motion of the traveling vehicle body 11 as the attitude of the traveling vehicle body 11. The attitude detector 106 is, for example, an inertial measurement unit (IMU) including an acceleration sensor, a gyroscope sensor, and the like. The attitude detector 106 detects, for example, tilt information (roll, pitch, and yaw angles) of the traveling vehicle body 11.

As illustrated in FIG. 1, the electric working vehicle 1 includes an input interface E. The input interface E receives input of information. The input interface E is communicably connected with the controller 101, and outputs the received input information to the controller 101.

The input interface E is configured to, for example, receive input of an operation performed by the operator, and output information based on the operation (such as operation information or operation signal) to the controller 101. In such a case, the input interface E includes one or more operation actuators to receive input of an operation performed by the operator. Such an operation actuator is of a hardware type such as a physical lever or switch, or of a software type such as a display image that is displayed on the display screen 103a of the display 103 and that can be operated on. An operation actuator of a software type is configured to receive input of an operation when the operator operates a touchscreen.

As illustrated in FIG. 1, the controller 101 is configured or programmed to acquire input information received via the input interface E and, based on the acquired information, control various devices, various equipment, and the like of the electric working vehicle 1. A specific example of a traveling control performed by the controller 101 will now be described.

The input interface E receives input of a traveling instruction, which is an instruction related to traveling of the traveling device 21. In response to the input interface E receiving input of a traveling instruction, the controller 101 acquires the traveling instruction, and controls traveling performed by the traveling device 21. An example of the traveling instruction may be an operation instruction for the power supply 31.

The input interface E configured to receive input of an operation instruction (traveling instruction) for the power supply 31 is, for example, a travel operation actuator 57. The travel operation actuator 57 includes the accelerator operation actuator 32. The accelerator operation actuator 32 receives input of an operation related to the power to be supplied from the power supply 31 to the traveling device 21. The accelerator operation actuator 32 includes, for example, a component such as an accelerator pedal or an accelerator lever. The accelerator operation actuator 32 detects an operation of such a component (such as the direction of operation and/or the amount of operation) via a sensor, and outputs the detected operation to the controller 101 as an operation signal.

The controller 101 is configured or programmed to, in response to acquiring an operation signal (e.g., a traveling instruction or an operation instruction) from the accelerator operation actuator 32, control the power supply 31 based on a predetermined control table, a computational expression, or the like stored in the storage assembly 102 and based on the acquired operation signal. Specifically, the controller 101 is configured or programmed to, based on an operation signal from the accelerator operation actuator 32, control the number of revolutions of the first motor/generator 34 to control the traveling device 21.

The controller 101 is configured or programmed to, in response to an operation signal provided from the accelerator operation actuator 32, control the inverter 74, and change, as desired, the current and voltage of the electric power to be supplied to the first motor/generator 34. For example, as the amount of operation of the accelerator operation actuator 32 increases, the controller 101 increases the electric power to be supplied to the first motor/generator 34 to increase the number of revolutions of the first motor/generator 34. As the amount of operation of the accelerator operation actuator 32 decreases, the controller 101 reduces the electric power to be supplied to the first motor/generator 34 to reduce the number of revolutions of the first motor/generator 34.

As illustrated in FIGS. 1 and 5, the travel operation actuator 57 includes a forward and rearward switching operation actuator 57A. The forward and rearward switching operation actuator 57A is an operation actuator including a forward-travel position F, a rearward-travel position R, and a neutral position N and configured to be operated to switch the direction of travel of the traveling vehicle body 11. The forward and rearward switching operation actuator 57A is, for example, a shuttle lever 57A1 swingably supported near the steering wheel 42a. The shuttle lever 57A1 is configured to switch between the forward-travel position F, the rearward-travel position R, and the neutral position N.

A traveling instruction may be any operation instruction related to traveling performed by the traveling device 21, and is not limited to an operation instruction for the power supply 31. For example, in a case where the controller 101 is configured or programmed to control the brake 51 as illustrated in FIG. 2, the input interface E may receive input of an operation instruction for the brake 51 as a traveling instruction.

The brake 51 in FIG. 2 includes a hydraulic actuator 54. The hydraulic actuator 54 is actuated by hydraulic fluid, and actuates the brake mechanism 53. The hydraulic actuator 54 includes a first hydraulic actuator 54a to actuate the first brake mechanism 53a, and a second hydraulic actuator 54b to actuate the second brake mechanism 53b. The first hydraulic actuator 54a and the second hydraulic actuator 54b are, for example, brake master cylinders. Although two hydraulic actuators, the first hydraulic actuator 54a and the second hydraulic actuator 54b, are depicted in FIG. 2, a single hydraulic actuator 54 (e.g., brake master cylinder) may actuate the first brake mechanism 53a and the second brake mechanism 53b.

A first brake control valve 55a is connected to the first hydraulic actuator 54a via a fluid passage. The first brake control valve 55a is, for example, a solenoid valve. The first brake control valve 55a is controlled by the controller 101, and actuates the first hydraulic actuator 54a. A second brake control valve 55b is connected to the second hydraulic actuator 54b via a fluid passage. The second brake control valve 55b is, for example, a solenoid valve. The second brake control valve 55b is controlled by the controller 101, and actuates the second hydraulic actuator 54b.

The input interface E configured to receive input of an operation instruction (traveling instruction) for the brake mechanism 53 is, for example, the brake operation actuator 52. In such a case, the brake operation actuator 52 detects, via a sensor, an operation (such as the direction of operation or the amount of operation) of each of the brake pedal 52a, the parking brake 56, and the like, and outputs the detected operation to the controller 101 as an operation signal.

The controller 101 is configured or programmed to, in response to acquiring an operation signal (e.g., a traveling instruction or an operation instruction) from the brake operation actuator 52 while the traveling vehicle body 11 is traveling, perform a blended regenerative braking control based on the pieces of information including a predetermined control table, a computational expression, or the like stored in the storage assembly 102, the operation signal, and the number of revolutions of each first motor/generator 34. A blended regenerative braking control refers to a braking control in which the braking force (hydraulic braking force) produced by the brake mechanism 53 (hydraulic brake) and the braking force (regenerative braking force) produced by regeneration are blended to provide a braking force corresponding to an operation signal output from the brake operation actuator 52.

The controller 101 is configured or programmed to, based on an operation signal from the brake operation actuator 52 and based on the number of revolutions of each first motor/generator 34, compute a braking force and, by using the control table, the computational expression, or the like mentioned above, perform a computation for distributing the braking force between regenerative braking and hydraulic braking and generate a regenerative braking force and a hydraulic braking force. For example, the controller 101 is configured or programmed to, when a light brake operation is performed (when the amount of operation of the brake operation actuator 52 is a first amount of operation), generate only a regenerative braking force and, when a strong brake operation is performed (when the amount of operation of the brake operation actuator 52 is a second amount of operation greater than the first amount of operation), generate a regenerative braking force and a hydraulic braking force.

Specifically, the controller 101 is configured or programmed to, until the number of revolutions of the first motor/generator 34 is reduced (lowered) to a target number of revolutions, place the first motor/generator 34 in a regenerative state and thus cause the first motor/generator 34 to generate a regenerative braking force. A regenerative state refers to a state in which the first motor/generator 34 is rotated by the kinetic energy of the traveling vehicle body 11 to recover the kinetic energy of the traveling vehicle body 11 as electric energy. During regenerative braking that uses the first motor/generator 34 whose number of revolutions is controlled, the target number of revolutions is set to be lower than the actual number of revolutions. This causes the first motor/generator 34 to generate negative torque to thus charge the battery 70. Furthermore, the controller 101 is configured or programmed to prevent or reduce the likelihood of sudden braking by setting a threshold for the negative torque (negative value) or by setting a threshold for the rate of change in number of revolutions (the amount of change in number of revolutions per unit time). The controller 101 is also configured or programmed to output, to the brake control valve (the first brake control valve 55a and/or the second brake control valve 55b), a control signal corresponding to a hydraulic braking force, and actuate the brake mechanism 53 to thus generate a hydraulic braking force (i.e., apply a hydraulic brake). Although, in the blended regenerative brake control, regenerative braking is performed during an early stage of the braking period and hydraulic braking is performed after the regenerative braking, regenerative braking and hydraulic braking may be performed simultaneously during the entire braking period or at least during a later stage of the braking period.

As for the hydraulic braking force, as the amount of operation of the brake pedal 52a increases, the controller 101 reduces the respective openings of the first brake control valve 55a and the second brake control valve 55b and, via the hydraulic actuator 54, increases the braking force to be provided by the brake mechanism 53. As the amount of operation of the brake pedal 52a decreases, the controller 101 increases the respective openings of the first brake control valve 55a and the second brake control valve 55b and, via the hydraulic actuator 54, reduces the braking force to be provided by the brake mechanism 53.

The input interface E configured to receive input of an operation instruction (traveling instruction) for the steering device 41 is, for example, the steering operation actuator 42. In such a case, the steering operation actuator 42 detects, via a sensor, the rotation direction and rotation angle of the steering wheel 42a, and outputs the detected rotation direction and the detected rotation angle to the controller 101 as an operation signal.

The controller 101 is configured or programmed to, in response to acquiring an operation signal (e.g., a traveling instruction or an operation instruction) from the steering operation actuator 42, control the steering of the front wheels 22F based on a predetermined table, a computational expression, or the like stored in the storage assembly 102 and based on the acquired operation signal. Specifically, the controller 101 is configured or programmed to switch the steering control valve 44 in response to the operation signal from the steering operation actuator 42, and move the arm 46 in response to the extension or retraction of the steering cylinder 45 to thus change the steering of the front wheels 22F.

More specifically, as the amount of operation of the steering wheel 42a increases, the controller 101 increases the opening of the steering control valve 44, and increases the turning angle via the steering cylinder 45. As the amount of operation of the steering wheel 42a decreases, the controller 101 reduces the opening of the steering control valve 44, and reduces the turning angle via the steering cylinder 45.

The input interface E may receive input of a work instruction related to the work to be performed by the working device 2, in addition to or instead of a traveling instruction. In response to the input interface E receiving input of a work instruction, the controller 101 acquires the work instruction, and controls the work to be performed by the working device 2. An example of the work instruction may be an operation instruction for the lifter 63.

The input interface E configured to receive input of an operation instruction (traveling instruction) for the lifter 63 is, for example, a lifter actuator 62. The lifter actuator 62 receives input of an operation to raise or lower the lifter 63. The lifter actuator 62 includes, for example, a raising and lowering lever. The lifter actuator 62 detects, via a sensor, an operation (such as the direction of operation or the amount of operation) of the raising and lowering lever, and outputs the detected operation to the controller 101 as an operation signal. The lifter actuator 62 may include a separate raising and lowering switch in addition to the raising and lowering lever, and output an operation signal detected via the raising and lowering switch to the controller 101.

The controller 101 is configured or programmed to, in response to acquiring an operation signal (e.g., a work instruction or an operation instruction) from the lifter actuator 62, control the lifter 63 based on a predetermined control table, a computational expression, or the like stored in the storage assembly 102 and based on the acquired operation signal. Specifically, the controller 101 is configured or programmed to control the raising and lowering control valve 63f in response to the operation signal output from the lifter actuator 62, and change either the hydraulic fluid that is to be supplied from the hydraulic pump 38 to the lift cylinder 63e via the raising and lowering control valve 63f or the hydraulic fluid that is to be discharged from the lift cylinder 63e via the raising and lowering control valve 63f.

A work instruction may be any operation instruction related to the work to be performed by the working device 2, and is not limited to an operation instruction for the lifter 63. For example, the input interface E may receive input of, as a work instruction, an operation instruction for the PTO shaft 36.

The input interface E configured to receive input of an operation instruction (work instruction) for the PTO shaft 36 includes, for example, a working device operation actuator 58. The working device operation actuator 58 includes a rotation operation actuator 33. The rotation operation actuator 33 is an operation actuator used by the operator in indicating the number of revolutions of the PTO shaft 36 to speed-change the rotational power of the PTO shaft 36. The rotation operation actuator 33 includes, for example, a lever or the like configured to switch between a plurality of positions. The rotation operation actuator 33 detects an operation (switched position) of the lever or the like via a sensor, and outputs the detected operation to the controller 101 as an operation signal. The rotation operation actuator 33 is, for example, a PTO speed lever. The rotation operation actuator 33 is not limited to a lever but may be a dial or the like.

The controller 101 is configured or programmed to, in response to acquiring an operation signal (e.g., a work instruction or an operation instruction) from the rotation operation actuator 33, control the second motor/generator 37, which is configured to rotate the PTO shaft 36, based on a predetermined control table, a computational expression, or the like stored in the storage assembly 102 and based on the acquired operation signal.

Specifically, the controller 101 is configured or programmed to, in response to an operation signal from the rotation operation actuator 33, control the inverter 74 used for the second motor/generator 37, and change, as desired, the current and voltage of the electric power to be supplied to the second motor/generator 37. For example, as the amount of operation of the rotation operation actuator 33 increases, the controller 101 increases the electric power to be supplied to the second motor/generator 37 to increase the number of revolutions of the PTO shaft 36. As the amount of operation of the rotation operation actuator 33 decreases, the controller 101 reduces the electric power to be supplied to the second motor/generator 37 to reduce the number of revolutions of the PTO shaft 36.

The working device operation actuator 58 includes a PTO switch 59. The PTO switch 59 is a switch configured to switch between a connected state in which power from the second motor/generator 37 is transmitted to the PTO shaft 36, and a disconnected state in which the power is not transmitted to the PTO shaft 36. When the PTO switch 59 is in an on state, the second motor/generator 37 and the PTO shaft 36 are connected to each other, and when the PTO switch 59 is in an off state, the second motor/generator 37 and the PTO shaft 36 are disconnected from each other.

The input interface E is not limited to the example mentioned above. In a case where the electric working vehicle 1 is configured to be operated by automatic control, the input interface E may include an operation switch to control the start, end, or the like of the automatic control.

The input interface E may be any input interface configured to receive input of information and to output the received input information to the controller 101. The input interface E is thus not limited to an operation actuator configured to receive input of an operation performed by the operator. For example, the input interface E may include a communicator 107 to receive information transmitted from an external source. The communicator 107 is a communication interface for the electric working vehicle 1, and includes a communication circuit. The communicator 107 wirelessly communicates with an external server, a mobile terminal, a remote manual operator, and/or the like via, for example, a communication standard such as the IEEE 802.11 series Wireless Fidelity (Wi-Fi) (registered trademark), a mobile phone network, or a data communication network. The communicator 107 wirelessly communicates with a server and/or the like, and receives various information, data, signals, and the like. The communicator 107 may also function as an output interface configured to output (transmit) various information, data, signals, and the like to the server and/or the like.

For example, in a case where the electric working vehicle 1 is configured to be operated by remote control, the communicator 107 receives an operation instruction (a traveling instruction and/or a work instruction) transmitted from a remote manual operator, and outputs the operation instruction to the controller 101 as an operation signal. Accordingly, in response to acquiring such operation signals (operation instructions), the controller 101 controls the corresponding devices or the corresponding pieces of equipment based on the operation signals. In a case where the electric working vehicle 1 is configured to be operated by automatic control, the communicator 107 receives an operation instruction (a traveling instruction and/or a work instruction) transmitted from a remote control used to control the start, end, or the like of the automatic control, and outputs the operation instruction to the controller 101 as an operation signal. Accordingly, in response to acquiring such operation signals (operation instructions), the controller 101 controls the start, end, or the like of the automatic control based on the operation signals.

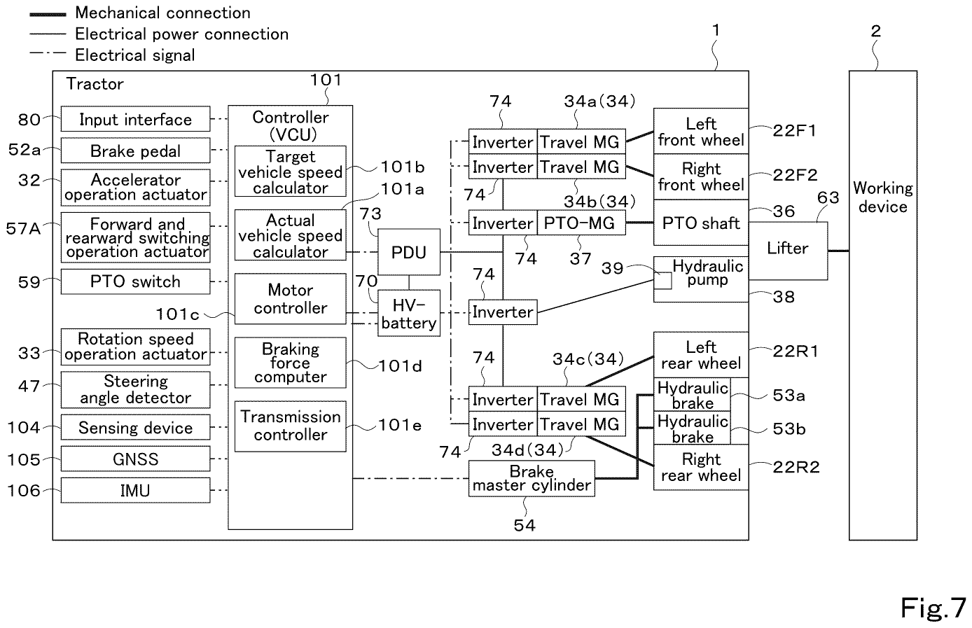

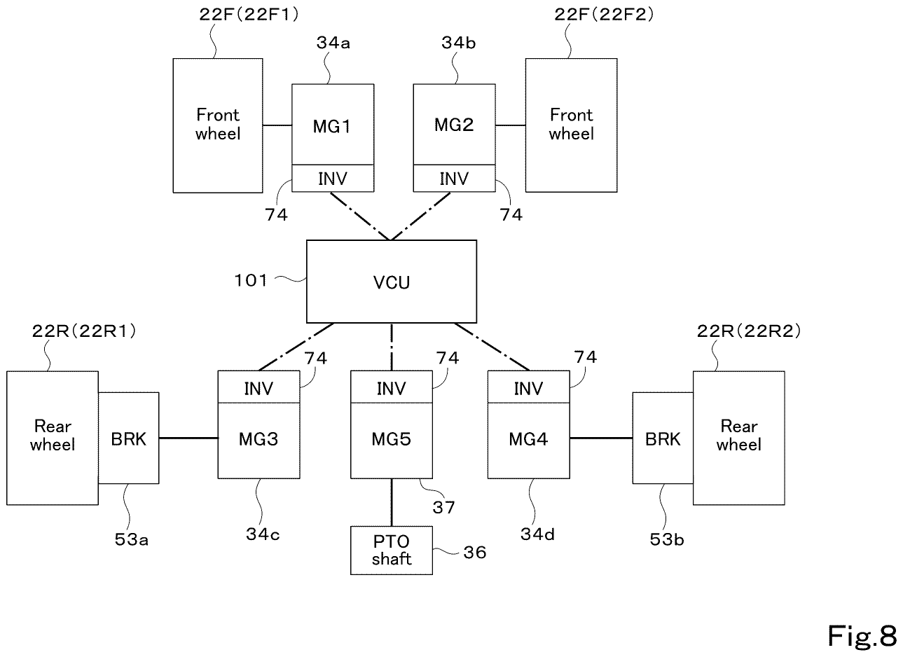

The configuration of the controller 101 and the traveling control performed by the controller 101 will now be described in detail with reference to FIGS. 7 and 8. FIG. 7 illustrates the controller 101 of the electric working vehicle 1, its associated devices, and the like. FIG. 8 illustrates a control of the first motor/generators 34 and the brake mechanism 53 performed by the controller 101.

As illustrated in FIGS. 1 and 7, the electric working vehicle 1 includes one or more rotation detectors 108. The rotation detector 108 is communicably connected with the controller 101, and outputs a detection result to the controller 101. The rotation detector 108 detects the rotation of the traveling device 21. The rotation detector 108 is, for example, an optical or magnetic rotation sensor. For example, the rotation detector 108 detects the rotation of the traveling device 21 as a pulse signal, and outputs the pulse signal to the controller 101. According to the present example embodiment, the rotation detector 108 is provided to the output shaft of each first motor/generator 34.

As illustrated in FIG. 7, the controller 101 includes an actual vehicle speed calculator 101a, a target vehicle speed calculator 101b, a motor controller 101c, a braking force computer 101d, and a transmission controller 101e.

The actual vehicle speed calculator 101a calculates the actual speed of the traveling device 21. For example, the actual vehicle speed calculator 101a is configured to, based on a detection result output from the rotation detector 108, compute the number of revolutions of the traveling device 21 per predetermined time and, from the computed number of revolutions of the traveling device 21, calculate the actual vehicle speed of the traveling device 21. Although the actual vehicle speed is determined (i.e., the actual vehicle speed is detected) by use of the rotation detector 108 (i.e., a wheel speed sensor) in the present case, this does not imply any limitation. For example, as a variation, a configuration may be used in which the inverter 74 (or the controller 101) calculates, from the value of current or frequency and the specifications of the first motor/generator 34, the number of motor revolutions, and computes the actual number of revolutions by multiplying the number of revolutions of the first motor/generator 34 by the gear ratio.

The target vehicle speed calculator 101b calculates a target vehicle speed of the traveling device 21 based on the amount of operation of the accelerator operation actuator 32 and based on the actual vehicle speed of the traveling device 21 that has been calculated by the actual vehicle speed calculator 101a. For example, the target vehicle speed increases in proportion to the amount of operation of the accelerator operation actuator 32.

The motor controller 101c is configured or programmed to control the driving of the first motor/generator 34 and the driving of the second motor/generator 37. For example, the motor controller 101c calculates a target number of revolutions of each first motor/generator 34 from a target vehicle speed calculated by the target vehicle speed calculator 101b. As illustrated in FIGS. 7 and 8, the motor controller 101c controls each of the inverters 74 such that the electric power to be supplied to the corresponding one of the first motor/generators 34 (the travel MGs 34a to 34d) changes to a value for achieving the target number of revolutions. The motor controller 101c thus sets each first motor/generator 34 to the target number of revolutions.

The braking force computer 101d is configured or programmed to, based on the amount of pressing operation of the brake pedal 52a and based on the number of revolutions of each first motor/generator 34 detected by the rotation detector 108, compute a braking force, and perform a computation for distributing the braking force between regenerative braking and hydraulic braking. The target vehicle speed calculator 101b calculates a number of revolutions corresponding to the regenerative braking force. The motor controller 101c is configured or programmed to, until the number of revolutions of each of the first motor/generators 34 reaches a number of revolutions corresponding to the target vehicle speed that has been calculated by the target vehicle speed calculator 101b and that is less than the actual vehicle speed, place each of the first motor/generator 34 in a regenerative state via the corresponding one of the inverters 74. In a case where a share of the braking force is to be allocated to hydraulic braking, after the regenerative braking is applied by each first motor/generator 34, the braking force computer 101d outputs a control signal corresponding to the hydraulic braking force to the brake control valve (the first brake control valve 55a and/or the second brake control valve 55b in FIG. 2) and, as illustrated in FIGS. 7 and 8, the brake mechanism 53 (the first brake mechanism 53a and the second brake mechanism 53b) is actuated with the hydraulic braking force via the hydraulic actuator 54 (brake master cylinder).

The rotation detector 108 may be configured to detect, within the power transmission path from each first motor/generator 34 that drives the corresponding wheel 22 to the wheel 22, the rotation of the axle of the wheel 22 or the rotation of a predetermined gear. For example, in a case where the rotation detector 108 detects the rotation of a predetermined gear within the power transmission path, the actual vehicle speed calculator 101a translates the rotation of the gear into the rotation of each wheel 22, based on a predetermined computational expression or the like stored in the storage assembly 102.

The transmission controller 101e is configured or programmed to control the transmission 35. The transmission 35 includes, for example, stepped transmission gears configured to switch between a first speed stage (low speed) and a second speed stage (high speed). For example, the transmission controller 101e is configured or programmed to, when the shift lever is in an operating position indicating the first speed stage (low speed), switch the transmission 35 to the first speed stage (low speed) and, when the shift lever is in an operating position indicating the second speed stage (high speed), switch the transmission 35 to the second speed stage (high speed).

The motor controller 101c is configured or programmed to, in response to the shuttle lever 57A1 being switched to the forward-travel position F, switch the rotation of the first motor/generator 34 from reverse to forward, so that the power due to the forward rotation of the first motor/generator 34 is transmitted to the wheels 22 and the traveling vehicle body 11 thus moves forward. The motor controller 101c is configured or programmed to, in response to the shuttle lever 57A1 being switched to the rearward-travel position R, switch the rotation of the first motor/generator 34 from forward to reverse, so that the power due to the reverse rotation of the first motor/generator 34 is transmitted to the wheels 22 and the traveling vehicle body 11 thus moves rearward.

As illustrated in FIG. 1, the electric working vehicle 1 includes a radiator 76. The radiator 76 cools cooling water used to cool electrical equipment such as the battery 70. The radiator 76 includes a radiator fan 76a and a heat exchanger. The heat of the cooling water is dissipated to the external environment through the heat exchanger, and the ambient air around the heat exchanger is discharged to the outside of the electric working vehicle 1 by, for example, the radiator fan 76a that is a blower-type radiator fan. The radiator 76 may be configured to cool the cooling water by cooling the heat exchanger with air supplied to the heat exchanger from the radiator fan 76a that is a suction-type radiator fan.

The electric working vehicle 1 is configured to, when there is no charger in the vicinity and the remaining charge of the battery 70 has decreased, perform regenerative charging using external power (power from another vehicle 200), rather than traveling under its own power. Regenerative charging using external power (which can be referred to as emergency regenerative charging) will now be described below.

As illustrated in FIG. 1, the electric working vehicle 1 includes the input interface 80 to receive input of an instruction to enter a regenerative mode. The input interface 80 is configured to, for example, receive input of an instruction to enter a regenerative mode in which at least one of the first motor/generator 34 or the second motor/generator 37 is driven regeneratively to charge the battery 70.

As illustrated in FIG. 1, the input interface 80 includes, for example, the display 103. The display 103 includes a touchscreen as the display screen 103a, and is configured to receive input of various instructions via the touchscreen. The input interface 80 may be the input interface E of various types such as a mouse, a keyboard, and an audio input interface, instead of the display 103 or in addition to the display 103.

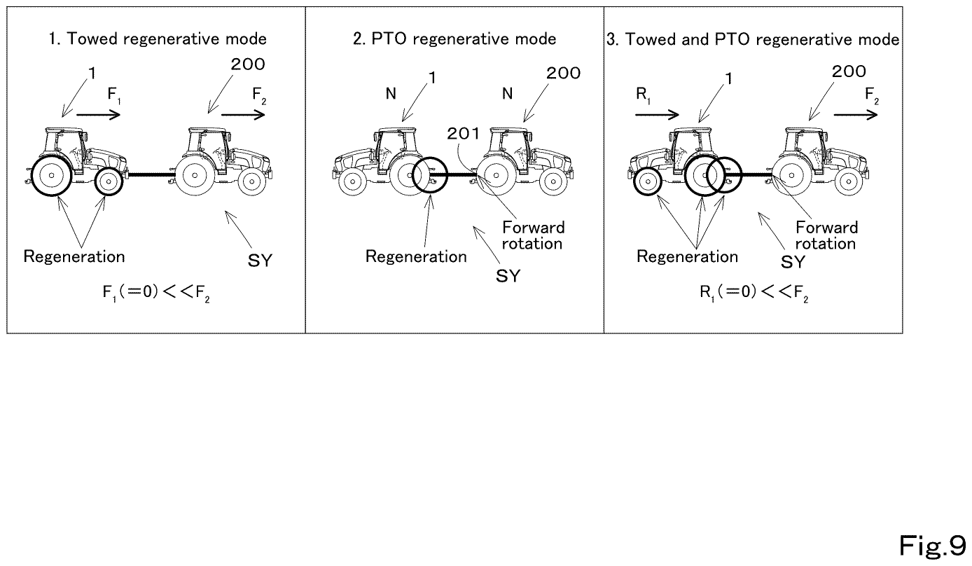

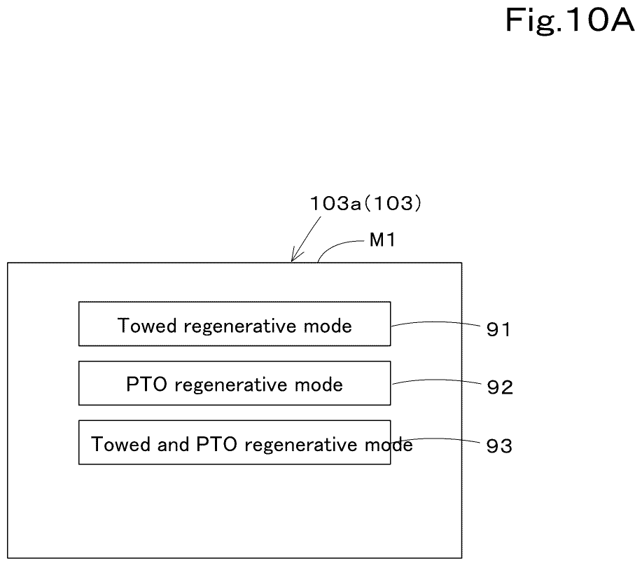

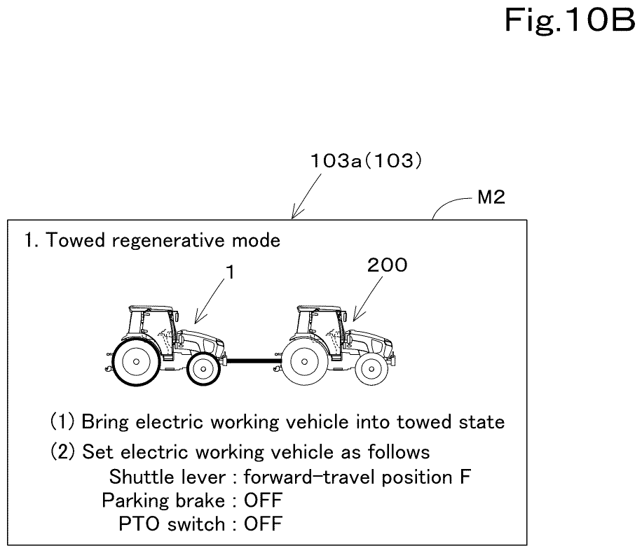

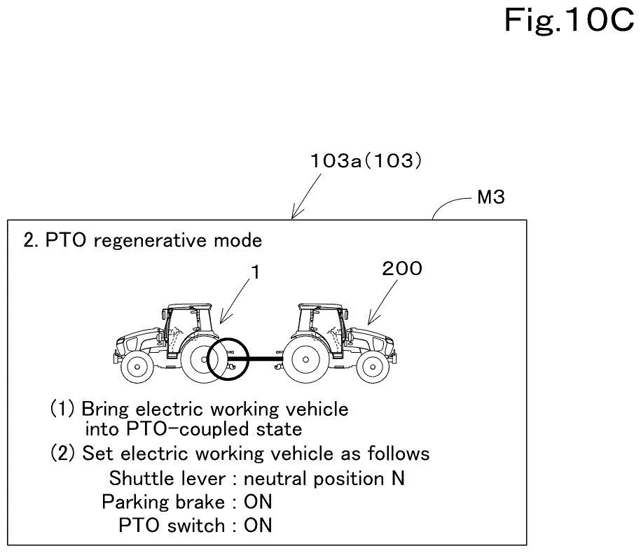

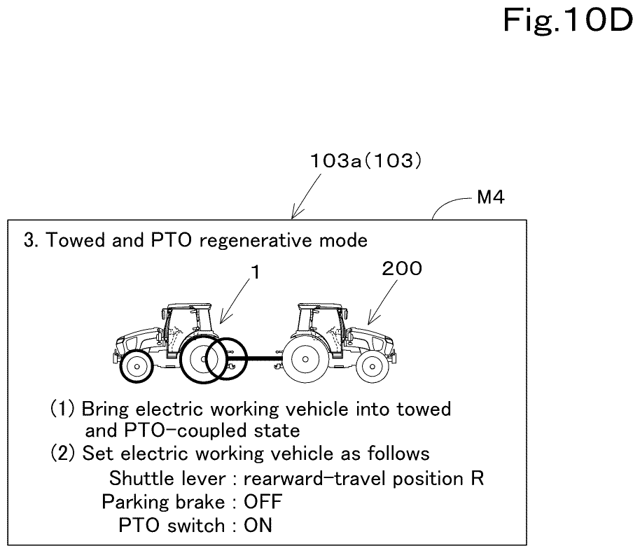

FIG. 9 illustrates three regenerative modes. As illustrated in FIG. 9, the regenerative modes include at least a towed regenerative mode and a PTO regenerative mode. The input interface 80 is configured to receive input of an instruction to enter the towed regenerative mode or the PTO regenerative mode. FIG. 10A illustrates an example of a selection screen M1 to select a regenerative mode. As illustrated in FIG. 10A, the controller 101 causes the display 103 to display the selection screen M1 to select a regenerative mode. The selection screen M1 includes an item area 91 indicating the towed regenerative mode, and an item area 92 indicating the PTO regenerative mode.

As illustrated on the left-hand side of FIG. 9, the towed regenerative mode is a regenerative mode in which the traveling vehicle body 11 is towed to rotate the wheels 22 to regeneratively drive the first motor/generator 34. That is, the towed regenerative mode is a regenerative mode in which the other vehicle 200 tows the traveling vehicle body 11 in the forward direction to rotate the four wheels 22 of the towed traveling vehicle body 11, so that each of the four first motor/generators 34 is driven regeneratively to regeneratively charge the battery 70. The other vehicle 200 may be any vehicle other than the electric working vehicle 1. The other vehicle 200 may be either an electric working vehicle or a non-electric working vehicle (such as a gasoline-powered or diesel-powered working vehicle).

As illustrated in the middle of FIG. 9, the PTO regenerative mode is a regenerative mode in which the PTO shaft 36 is rotated by external power to regeneratively drive the second motor/generator 37. That is, the PTO regenerative mode is a regenerative mode in which, when the PTO shaft 36 of the electric working vehicle 1 is coupled with an output shaft 201 of the other vehicle 200 and the other vehicle 200 and the electric working vehicle 1 are in a stopped state, the rotational force of the output shaft 201 of the other vehicle 200 rotates the PTO shaft 36 of the electric working vehicle 1, and the second motor/generator 37 is thus driven regeneratively to regeneratively charge the battery 70.

The motor controller 101c is configured or programmed to, when the electric working vehicle 1 is in the towed regenerative mode, control the driving of the first motor/generator 34 and the second motor/generator 37 such that the first motor/generator 34 is driven regeneratively and the second motor/generator 37 is stopped. The motor controller 101c is configured or programmed to, when the electric working vehicle 1 is in the PTO regenerative mode, control the driving of the first motor/generator 34 and the second motor/generator 37 such that the first motor/generator 34 is stopped and the second motor/generator 37 is driven regeneratively.

The regenerative modes may further include a towed and PTO regenerative mode. As illustrated on the right-hand side of FIG. 9, the towed and PTO regenerative mode is a regenerative mode in which the electric working vehicle 1 operates concurrently in both the towed regenerative mode and the PTO regenerative mode. In the towed and PTO regenerative mode, the output shaft 201 of the other vehicle 200 is coupled to the PTO shaft 36 of the electric working vehicle 1, and as the other vehicle 200 is caused to travel forward, the traveling vehicle body 11 of the electric working vehicle 1 is towed in the backward direction, and the four wheels 22 of the traveling vehicle body 11, which is now being towed backward, are thus rotated, which causes each of the four first motor/generators 34 to be driven regeneratively to regeneratively charge the battery 70. Further, in the towed and PTO regenerative mode, as the rotational force of the output shaft 201 of the other vehicle 200 rotates the PTO shaft 36 of the electric working vehicle 1, the second motor/generator 37 is driven regeneratively to regeneratively charge the battery 70.

The input interface 80 is configured or programmed to receive input of an instruction to enter one of the towed regenerative mode, the PTO regenerative mode, or the towed and PTO regenerative mode. The selection screen M1 in FIG. 10A includes an item area 93 indicating the towed and PTO regenerative mode, in addition to the item area 91 indicating the towed regenerative mode and the item area 92 indicating the PTO regenerative mode.

The motor controller 101c is configured or programmed to, when the electric working vehicle 1 is in the towed and PTO regenerative mode, control the driving of the first motor/generator 34 and the second motor/generator 37 such that the first motor/generator 34 and the second motor/generator 37 are driven regeneratively.

The notifier 110 is configured or programmed to, upon receipt by the input interface 80 of input of an instruction to enter a regenerative mode, provide a user with a notification prompting the user to change states of the travel operation actuator 57 and the working device operation actuator 58 to specified states based on the regenerative mode for which the instruction is received.

The notifier 110 is configured or programmed to, when the regenerative mode is the towed regenerative mode, provide the notification to prompt the user to bring the forward and rearward switching operation actuator 57A into the forward-travel position F, turn off the parking brake 56, and turn off the PTO switch 59.

Specifically, the notifier 110 (the display 103) provides the notification by displaying a notification screen M2 illustrated in FIG. 10B. FIG. 10B illustrates the notification screen M2 for the towed regenerative mode. As illustrated in FIG. 10B, the notification screen M2 includes a message that states “Bring electric working vehicle 1 into towed state.” In response to seeing this message, the user (operator) connects the other vehicle 200 and the electric working vehicle 1 to each other via a predetermined towing device (such as a towing drawbar) to bring the electric working vehicle 1 into a towed state. The notification screen M2 includes a message that states “Set electric working vehicle 1 as follows.” Based on a message on the notification screen M2 that indicates “shuttle lever: forward-travel position F, parking brake: OFF, PTO switch 59: OFF”, the user brings the shuttle lever 57A1 into the forward-travel position F, turns off the parking brake 56, and turns off the PTO switch 59.

The notifier 110 is configured or programmed to, when the regenerative mode is the PTO regenerative mode, provide the notification to prompt the user to bring the forward and rearward switching operation actuator 57A into the neutral position N, turn on the parking brake 56, and turn on the PTO switch 59.

Specifically, the notifier 110 (the display 103) provides the notification by displaying a notification screen M3 illustrated in FIG. 10C. FIG. 10C illustrates the notification screen M3 for the PTO regenerative mode. As illustrated in FIG. 10C, the notification screen M3 includes a message that states “Bring electric working vehicle 1 into a PTO-coupled state.” In response to seeing this message, the user couples the output shaft 201 of the other vehicle 200, and the PTO shaft 36 of the electric working vehicle 1 to each other. The user may couple these shafts to each other by using a predetermined coupling component. The notification screen M3 includes a message that states “Set electric working vehicle 1 as follows.” Based on a message on the notification screen M3 that indicates “shuttle lever: neutral position N, parking brake: ON, PTO switch 59: ON”, the user brings the shuttle lever 57A1 into the neutral position N, turns on the parking brake 56, and turns on the PTO switch 59.

The notifier 110 is configured or programmed to, when the regenerative mode is the towed and PTO regenerative mode, provide the notification to prompt the user to bring the forward and rearward switching operation actuator 57A into the rearward-travel position R, turn off the parking brake 56, and turn on the PTO switch 59.

Specifically, the notifier 110 (the display 103) provides the notification by displaying a notification screen M4 illustrated in FIG. 10D. FIG. 10D illustrates the notification screen M4 for the towed and PTO regenerative mode. As illustrated in FIG. 10D, the notification screen M4 includes a message that states “Bring electric working vehicle 1 into towed and PTO-coupled state.” In response to seeing this message, the user connects the other vehicle 200 and the electric working vehicle 1 to each other via a predetermined towing component (such as a towing drawbar), and couples the output shaft 201 of the other vehicle 200 and the PTO shaft 36 of the electric working vehicle 1 to each other. The notification screen M4 includes a message that states “Set electric working vehicle 1 as follows.” Based on a message on the notification screen M4 that indicates “shuttle lever: rearward-travel position R, parking brake: OFF, PTO switch 59: ON”, the user brings the shuttle lever 57A1 into the rearward-travel position R, turns off the parking brake 56, and turns on the PTO switch 59.

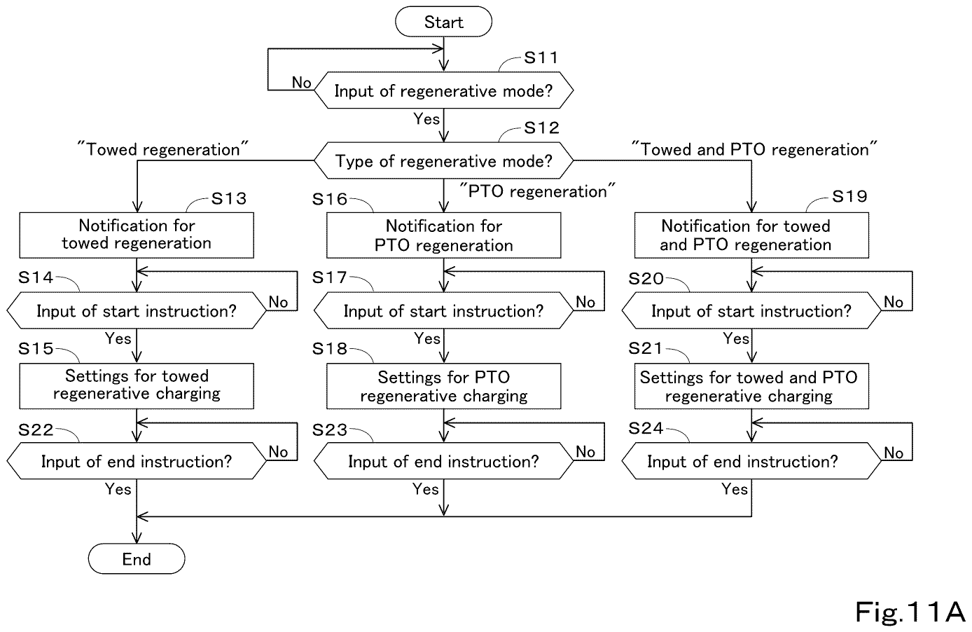

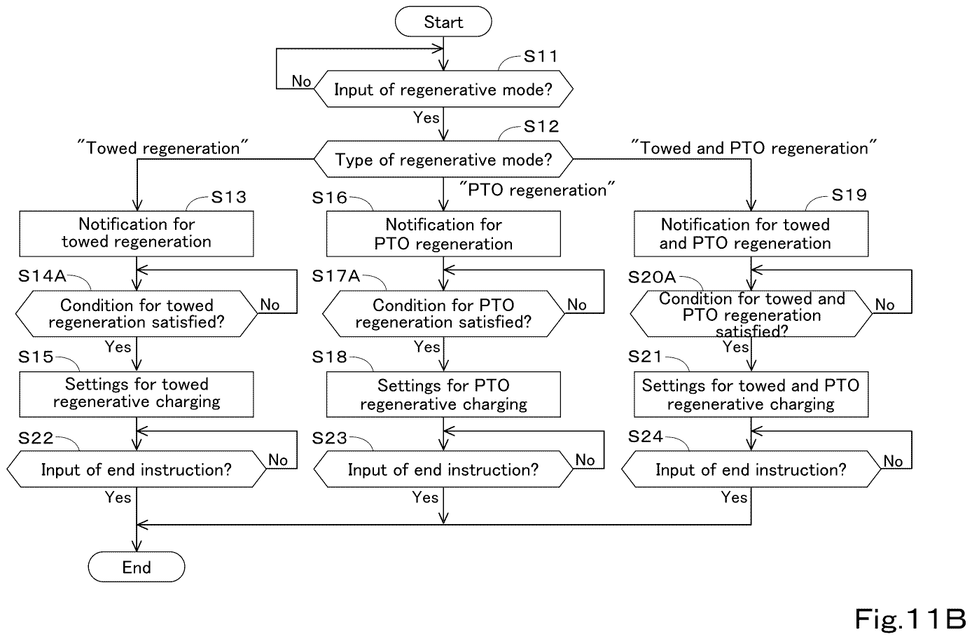

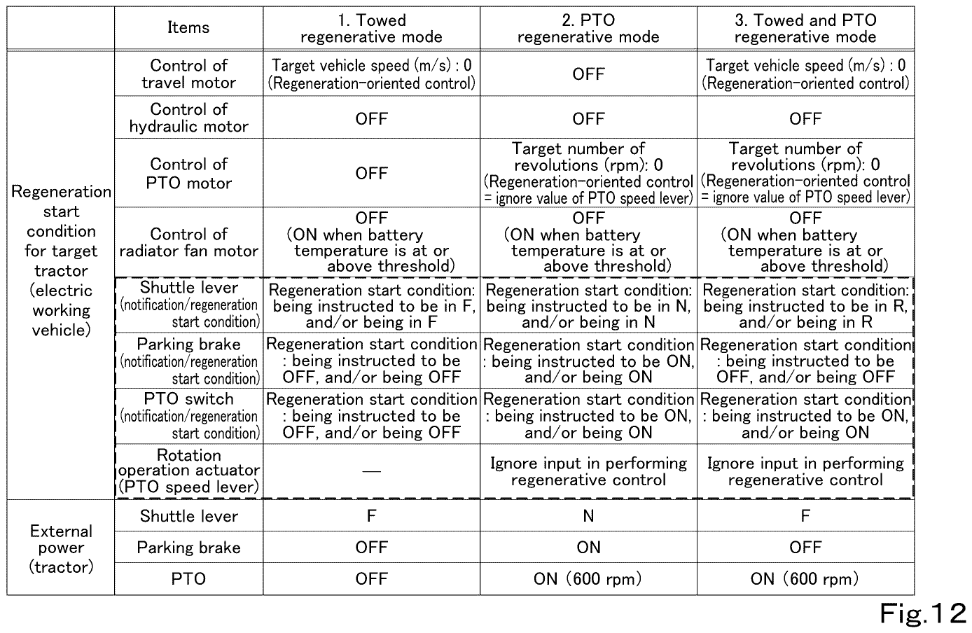

A control process performed by the controller 101 to control regenerative charging will now be described with reference to FIGS. 11A and 12. FIG. 11A is a flowchart illustrating an example of a control process performed by the controller 101 to control regenerative charging. FIG. 12 provides, for various regenerative modes of the electric working vehicle 1, descriptions of controls, descriptions of notifications, and descriptions for the settings for the other vehicle 200.

The controller 101 of the electric working vehicle 1 causes the display 103 to display the selection screen M1 illustrated in FIG. 10A, based on a predetermined operation performed by the user (e.g., an operation for displaying the selection screen M1). Then, as illustrated in FIG. 11A, the controller 101 determines whether a regenerative mode is input (S11). For example, when input of a regenerative mode is received by the input interface 80 (Yes at S11), the controller 101 determines the type of the regenerative mode (S12).

For example, when the user selects one of the item areas 91 to 93 on the selection screen M1, which is illustrated in FIG. 10A, of the display 103, the controller 101 determines the type of the regenerative mode corresponding to the selected one of the item areas (S12). The communicator 107 of the electric working vehicle 1 may receive information (information indicating the type of the regenerative mode) from the other vehicle 200, and the controller 101 may determine the type of the regenerative mode based on the information received by the communicator 107 (S12). The controller 101 may determine the type of the regenerative mode based on the state (a towed state, a PTO-coupled state described later, or a towed and PTO-coupled state) of the electric working vehicle 1 (S12).

When input of a regenerative mode is not received by the input interface 80 (No at S11), the controller 101 returns to S11, and waits until input of a regenerative mode is received by the input interface 80.

When input of the towed regenerative mode is received by the input interface 80 (“towed regeneration” at S12), the controller 101 causes the notifier 110 to execute a notification for towed regeneration (S13). For example, the display 103 provides a notification display prompting the user to make settings for towed regeneration, and the audio output device 103b outputs notification audio prompting the user to make settings for towed regeneration. The notification for towed regeneration need not necessarily be provided via both the notification display and the notification audio but may be provided via only the notification display or the notification audio.

The display 103 displays the notification screen M2 illustrated in FIG. 10B, which prompts the user to bring the shuttle lever 57A1 into the forward-travel position F, turn the parking brake 56 off (released position), and turn the PTO switch 59 off (off state). The audio output device 103b outputs notification audio that prompts the user to bring the shuttle lever 57A1 into the forward-travel position F, turn off the parking brake 56, and turn the PTO switch 59 off (off state). In the towed regenerative mode, the PTO switch 59 is turned off, and thus the display 103 and the audio output device 103b do not provide any particular notification for the rotation operation actuator 33.

The controller 101 determines whether input of a start instruction is received by the input interface 80 (S14). When input of a start instruction is received by the input interface 80 (Yes at S14), the controller 101 configures control settings for towed regenerative charging (S15). When input of a start instruction is not received by the input interface 80 (No at S14), the controller 101 returns to S14, and waits until input of a start instruction is received by the input interface 80.

As indicated in the “towed regenerative mode” column in FIG. 12, the controller 101 controls the travel motor (the first motor/generator 34) such that the target vehicle speed is set to “0” (i.e., the target number of revolutions is set to “0”). That is, the controller 101 performs a regeneration-oriented control, which is a control oriented toward regeneration. The controller 101 may control regeneration not by controlling the target vehicle speed to be “0” but by controlling the target vehicle speed to be lower than the current vehicle speed. The controller 101 turns off the electric motor 39, which drives the hydraulic pump 38, and turns off the PTO motor (the second motor/generator 37). Although the controller 101 turns off the radiator fan 76a, the radiator fan 76a may be controlled to turn on when the battery 70 is at or above a threshold temperature.

After S15, as for the other vehicle 200, as illustrated in FIG. 12, the parking brake is turned off, the PTO is turned off, and the other vehicle 200 is caused to travel forward (in the case of the other vehicle 200 including a shuttle lever, the shuttle lever is placed in the forward-travel position F) to tow the electric working vehicle 1 (the traveling vehicle body 11) in the forward direction. In the towed regenerative mode illustrated on the left-hand side of FIG. 9, the other vehicle 200 tows the traveling vehicle body 11 in the forward direction to rotate the four wheels 22 of the towed traveling vehicle body 11, so that each of the four first motor/generators 34 is driven regeneratively to regeneratively charge the battery 70.

The transmission controller 101e may bring the transmission 35 into the first speed stage when the electric working vehicle 1 is in the towed regenerative mode. Bringing the transmission 35 into the first speed stage makes it possible to improve the efficiency of charging performed through regenerative drive in the towed regenerative mode.

The controller 101 determines whether an end instruction is input (S22). For example, when the travel of the other vehicle 200 is stopped, and input of an end instruction is received by the input interface 80 of the electric working vehicle 1 whose towed travel is being stopped, the controller 101 determines that regenerative charging is to be ended (Yes at S22), and ends towed regenerative charging. When input of an end instruction is not received by the input interface 80 (No at S22), the controller 101 returns to S22, and waits for input of an end instruction.

Returning now to S12, when input of the PTO regenerative mode is received by the input interface 80 (“PTO regeneration” at S12), the controller 101 causes the notifier 110 to execute a notification for PTO regeneration (S16). For example, the display 103 provides a notification display prompting the user to make settings for PTO regeneration, and the audio output device 103b outputs notification audio prompting the user to make settings for PTO regeneration. The notification for PTO regeneration need not necessarily be provided via both the notification display and the notification audio but may be provided via only the notification display or the notification audio.

The display 103 displays the notification screen M3 illustrated in FIG. 10C, which prompts the user to bring the shuttle lever 57A1 into the neutral position N, turn the parking brake 56 on (braking position), and turn the PTO switch 59 on (on state). The audio output device 103b outputs notification audio that prompts the user to bring the shuttle lever 57A1 into the neutral position N, turn on the parking brake 56, and turn the PTO switch 59 on (on state). In the PTO regenerative mode, the PTO switch 59 is turned on, and the PTO shaft 36 is forced to rotate by the driving force from the other vehicle 200. Accordingly, the display 103 and the audio output device 103b provide a notification that the input from the rotation operation actuator 33 (the indication (instruction) of the number of revolutions of the PTO shaft 36 from the rotation operation actuator 33) is to be ignored in performing regenerative control.

The controller 101 determines whether input of a start instruction is received by the input interface 80 (S17). When input of a start instruction is received by the input interface 80 (Yes at S17), the controller 101 configures control settings for PTO regenerative charging (S18). When input of a start instruction is not received by the input interface 80 (No at S17), the controller 101 returns to S17, and waits until input of a start instruction is received by the input interface 80.

As indicated in the “PTO regenerative mode” field in FIG. 12, the controller 101 turns off the travel motor (the first motor/generator 34), and turns off the electric motor 39, which drives the hydraulic pump 38. The controller 101 sets the target number of revolutions of the PTO motor (the second motor/generator 37) to “0.” That is, the controller 101 performs a regeneration-oriented control in which an operation value from the rotation operation actuator 33 (PTO speed lever) is ignored. Although the controller 101 turns off the radiator fan 76a, the radiator fan 76a may be controlled to turn on when the battery 70 is at or above a threshold temperature.

After S18, as for the other vehicle 200, as illustrated in FIG. 12, the parking brake is turned on, the output shaft 201 (PTO) of the other vehicle 200 is turned on (e.g., the number of revolutions is set to 600 rpm), and the travel of the other vehicle 200 is stopped (the shuttle lever of the other vehicle 200 is placed in the neutral position N). Thus, with the travel of the electric working vehicle 1 (the traveling vehicle body 11) being stopped, the PTO shaft 36 of the electric working vehicle 1 is forced to be driven by the output shaft 201 (PTO) of the other vehicle 200. In the PTO regenerative mode illustrated in the middle of FIG. 9, the PTO shaft 36 of the electric working vehicle 1 is coupled to the output shaft 201 (PTO) of the other vehicle 200, and with the other vehicle 200 and the electric working vehicle 1 being in a stopped state, the rotational force of the output shaft 201 (PTO) of the other vehicle 200 rotates the PTO shaft 36 of the electric working vehicle 1, and the second motor/generator 37 is thus driven regeneratively to regeneratively charge the battery 70.

The controller 101 determines whether an end instruction is input (S23). For example, when the drive of the PTO shaft 36 by the other vehicle 200 is stopped, and input of an end instruction is received by the input interface 80 of the electric working vehicle 1, the controller 101 determines that regenerative charging is to be ended (Yes at S23), and ends PTO regenerative charging. When input of an end instruction is not received by the input interface 80 (No at S23), the controller 101 returns to S23, and waits for input of an end instruction.

Returning now to S12, when input of the towed and PTO regenerative mode is received by the input interface 80 (“towed/PTO regeneration” at S12), the controller 101 causes the notifier 110 to execute a notification for towed/PTO regeneration (S19). For example, the display 103 provides a notification display prompting the user to make settings for towed/PTO regeneration, and the audio output device 103b outputs notification audio prompting the user to make settings for towed/PTO regeneration. The notification for towed/PTO regeneration need not necessarily be provided via both the notification display and the notification audio but may be provided via only the notification display or the notification audio.

The display 103 displays the notification screen M4 illustrated in FIG. 10D, which prompts the user to bring the shuttle lever 57A1 into the rearward-travel position R, turn off the parking brake 56, and turn on the PTO switch 59. The audio output device 103b outputs notification audio that prompts the user to bring the shuttle lever 57A1 into the rearward-travel position R, turn off the parking brake 56, and turn on the PTO switch 59. In the towed and PTO regenerative mode, the PTO switch 59 is turned on, and the PTO shaft 36 is forced to rotate by the driving force from the other vehicle 200. Accordingly, the display 103 and the audio output device 103b provide a notification that the input from the rotation operation actuator 33 (the indication (instruction) of the number of revolutions of the PTO shaft 36 from the rotation operation actuator 33) is to be ignored in performing regenerative control.

The controller 101 determines whether input of a start instruction is received by the input interface 80 (S20). When input of a start instruction is received by the input interface 80 (Yes at S20), the controller 101 configures control settings for towed/PTO regenerative charging (S21). When input of a start instruction is not received by the input interface 80 (No at S20), the controller 101 returns to S20, and waits until input of a start instruction is received by the input interface 80.

As indicated in the “towed and PTO regenerative mode” column in FIG. 12, the controller 101 controls the travel motor (the first motor/generator 34) such that the target vehicle speed is set to “0” (i.e., the target number of revolutions is set to “0”) and the target number of revolutions of the PTO motor (the second motor/generator 37) is set to “0.” That is, the controller 101 ignores an operation value from the rotation operation actuator 33 (PTO speed lever). That is, the controller 101 performs a regeneration-oriented control for the first motor/generator 34 and the second motor/generator 37. The controller 101 may control regeneration not by controlling the target vehicle speed to be “0” but by controlling the target vehicle speed to be lower than the current vehicle speed. The controller 101 turns off the electric motor 39, which drives the hydraulic pump 38. Although the controller 101 turns off the radiator fan 76a, the radiator fan 76a may be controlled to turn on when the battery 70 is at or above a threshold temperature.

After S21, as for the other vehicle 200, as illustrated in FIG. 12, the parking brake is turned off, the PTO is turned on (e.g., the number of revolutions is set to 600 rpm), and the other vehicle 200 is caused to travel forward (the shuttle lever of the other vehicle 200 is placed in the forward-travel position F). Thus, the electric working vehicle 1 (the traveling vehicle body 11) is towed in the rearward direction, and the PTO shaft 36 of the electric working vehicle 1 is forced to be driven by the output shaft 201 (PTO) of the other vehicle 200. In the towed and PTO regenerative mode illustrated on the right-hand side of FIG. 9, the PTO shaft 36 is forced to be driven while the other vehicle 200 tows the traveling vehicle body 11 in the rearward direction. Thus, the four wheels 22 of the towed traveling vehicle body 11 are rotated, and the rotational force of the output shaft 201 (PTO) of the other vehicle 200 rotates the PTO shaft 36 of the electric working vehicle 1. As a result, each of the four first motor/generators 34 is driven regeneratively to regeneratively charge the battery 70, and the second motor/generator 37 is driven regeneratively to regeneratively charge the battery 70.

The transmission controller 101e may bring the transmission 35 into the first speed stage when the electric working vehicle 1 is in the towed and PTO regenerative mode. Bringing the transmission 35 into the first speed stage makes it possible to improve the efficiency of charging performed through regenerative drive in the towed and PTO regenerative mode.

The controller 101 determines whether an end instruction is input (S24). For example, when the travel of the other vehicle 200 is stopped, and an end instruction is received by the input interface 80 of the electric working vehicle 1 whose towed travel is being stopped, the controller 101 determines that regenerative charging is to be ended (Yes at S24), and ends towed/PTO regenerative charging. When input of an end instruction is not received by the input interface 80 (No at S24), the controller 101 returns to S24, and waits for input of an end instruction.

In FIG. 11A, upon receipt of a start instruction (S14, S17, and S20) after the notification for each type of regeneration is provided (S13, S16, and S19), the controller 101 configures settings for each type of regenerative charging (S15, S18, and S21). However, this does not imply any limitation. The controller 101 may determine whether a start condition is satisfied, instead of whether a start instruction is input. The controller 101 provides notification of a regeneration start condition as the above-mentioned notification.

For example, the motor controller 101c (the controller 101) is configured or programmed to, upon receipt by the input interface 80 of the instruction to enter the towed regenerative mode, determine that a regeneration start condition is satisfied when the forward and rearward switching operation actuator 57A is in the forward-travel position F, the parking brake 56 is off, and the PTO switch 59 is off, and control the driving of the first motor/generator 34 and the second motor/generator 37 such that the first motor/generator 34 is driven regeneratively and the second motor/generator 37 is stopped.

The motor controller 101c (the controller 101) is configured or programmed to, upon receipt by the input interface 80 of input of the instruction to enter the PTO regenerative mode, determine that a regeneration start condition is satisfied when the forward and rearward switching operation actuator 57A is in the neutral position N, the parking brake 56 is on, and the PTO switch 59 is on, and control the driving of the first motor/generator 34 and the second motor/generator 37 such that the first motor/generator 34 is stopped and the second motor/generator 37 is driven regeneratively.

The motor controller 101c (the controller 101) is configured or programmed to, upon receipt by the input interface 80 of input of the instruction to enter the towed and PTO regenerative mode, determine that a regeneration start condition is satisfied when the forward and rearward switching operation actuator 57A is in the rearward-travel position R, the parking brake 56 is off, and the PTO switch 59 is on, and control the driving of the first motor/generator 34 and the second motor/generator 37 such that the first motor/generator 34 and the second motor/generator 37 are driven regeneratively.

As illustrated in FIG. 11B, after S13, after S16, or after S19, the controller 101 determines whether a start condition is satisfied. FIG. 11B is a flowchart illustrating an example of a control process performed by the controller 101 to control regenerative charging. FIG. 11B differs from FIG. 11A in that S14, S17, and S20 in FIG. 11A are replaced with S14A, S17A, and S20A, respectively. Now, S14A, S17A, and S20A will be described in detail, and processes (steps) similar to those in FIG. 11A will not be described in further detail.

As illustrated in FIG. 11B, after S13, the controller 101 determines whether a condition for towed regeneration is satisfied (S14A).

After the notification for towed regeneration is provided (S13), the controller 101 determines whether a condition for the establishment of the towed regenerative mode illustrated in FIG. 12 is satisfied (S14A). Specifically, the condition for the establishment of the towed regenerative mode in FIG. 12 includes the forward and rearward switching operation actuator 57A is in the forward-travel position F (i.e., the shuttle lever 57A1 is in the forward-travel position F), the parking brake 56 is off, and the PTO switch 59 is off. Upon determining that the start condition for the towed regenerative mode is satisfied (Yes at S14A), the controller 101 controls the driving of the first motor/generator 34 and the second motor/generator 37 such that the first motor/generator 34 is driven regeneratively and the second motor/generator 37 is stopped (S15).

Upon determining that the start condition for the towed regenerative mode is not satisfied (No at S14A), the controller 101 returns to S14A, waits until the start condition is satisfied, and continues to provide the notification display illustrated in FIG. 10B. In providing the notification display illustrated in FIG. 10B, the controller 101 may enable recognition of the status of progress by varying, for the three items including the shuttle lever 57A1, the parking brake 56, and the PTO switch 59, the manner (such as brightness and color) in which each of the items is displayed depending on whether the corresponding condition is satisfied.

After the notification for PTO regeneration is provided (S16), the controller 101 determines whether a condition for the establishment of the PTO regenerative mode illustrated in FIG. 12 is satisfied (S17A). Specifically, the condition for the establishment of the PTO regenerative mode in FIG. 12 includes the forward and rearward switching operation actuator 57A is in the neutral position N (i.e., the shuttle lever 57A1 is in the neutral position N), the parking brake 56 is on, and the PTO switch 59 is on. Upon determining that the start condition for the PTO regenerative mode in FIG. 12 is satisfied (Yes at S17A), the controller 101 controls the driving of the first motor/generator 34 and the second motor/generator 37 such that the first motor/generator 34 is stopped and the second motor/generator 37 is driven regeneratively (S18).

Upon determining that the start condition for the PTO regenerative mode is not satisfied (No at S17A), the controller 101 returns to S17A, waits until the start condition is satisfied, and continues to provide the notification display illustrated in FIG. 10C. In providing the notification display illustrated in FIG. 10C, the controller 101 may enable recognition of the status of progress by varying, for the three items including the shuttle lever 57A1, the parking brake 56, and the PTO switch 59, the manner (such as brightness and color) in which each of the items is displayed depending on whether the corresponding condition is satisfied.

After the notification for towed/PTO regeneration is provided (S19), the controller 101 determines whether a condition for the establishment of the towed and PTO regenerative mode illustrated in FIG. 12 is satisfied (S20A). Specifically, the condition for the establishment of the towed and PTO regenerative mode in FIG. 12 includes the forward and rearward switching operation actuator 57A is in the rearward-travel position R (i.e., the shuttle lever 57A1 is in the rearward-travel position R), the parking brake 56 is off, and the PTO switch 59 is on. Upon determining that the start condition for the towed and PTO regenerative mode in FIG. 12 is satisfied (Yes at S20A), the controller 101 controls the driving of the first motor/generator 34 and the second motor/generator 37 such that the first motor/generator 34 and the second motor/generator 37 are driven regeneratively (S21).

Upon determining that the start condition for the towed and PTO regenerative mode is not satisfied (No at S20A), the controller 101 returns to S20A, waits until the start condition is satisfied, and continues to provide the notification display illustrated in FIG. 10D. In providing the notification display illustrated in FIG. 10D, the controller 101 may enable recognition of the status of progress by varying, for the three items including the shuttle lever 57A1, the parking brake 56, and the PTO switch 59, the manner (such as brightness and color) in which each of the items is displayed depending on whether the corresponding condition is satisfied.

Although the foregoing description is directed to the electric working vehicle 1, a regenerative charging assistance system SY including the electric working vehicle 1 and the other vehicle 200 may be provided as illustrated in FIG. 9. The other vehicle 200 includes the output shaft 201 (PTO) to couple the PTO shaft 36 of the electric working vehicle 1 thereto and configured to tow the electric working vehicle 1. The towed regenerative mode is a regenerative mode in which the other vehicle 200 tows the electric working vehicle 1 (the traveling vehicle body 11) to rotate the wheels 22 to regeneratively drive the first motor/generator 34. The PTO regenerative mode is a regenerative mode in which, when the PTO shaft 36 is coupled to the output shaft 201 of the other vehicle 200, power from the output shaft 201 rotates the PTO shaft 36 to regeneratively drive the second motor/generator 37.

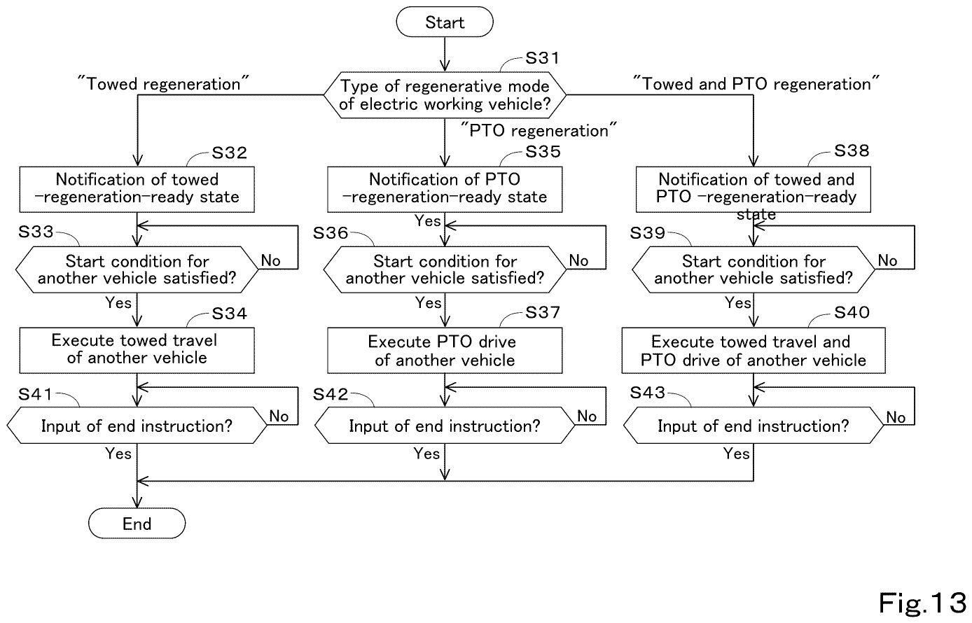

As illustrated in FIG. 13, the other vehicle 200 (e.g., a controller included in the other vehicle 200) may determine whether a start condition is satisfied with respect to the other vehicle 200. FIG. 13 is a flowchart illustrating an example of a control process for the other vehicle 200.

As illustrated in FIG. 13, the other vehicle 200 determines the type of the regenerative mode of the electric working vehicle 1 (S31). For example, the other vehicle 200 is configured to receive mode information transmitted from the electric working vehicle 1 and indicating the type of the regenerative mode of the electric working vehicle 1. Alternatively, the other vehicle 200 receives mode information input by the user (driver) of the other vehicle 200. The other vehicle 200 determines the type of the regenerative mode of the electric working vehicle 1 based on the mode information of the electric working vehicle 1.

When the mode information indicates towed regeneration (“towed regeneration” at S31), the other vehicle 200 provides a notification that the electric working vehicle 1 is in a towed-regeneration-ready state (S32). The other vehicle 200 determines whether a start condition is satisfied (S33). As illustrated in FIG. 12, the other vehicle 200 determines that the start condition is satisfied when the parking brake is turned off, the PTO is turned off, and the other vehicle 200 is traveling forward (the shuttle lever of the other vehicle 200 is placed in the forward-travel position F) (Yes at S33). When the start condition is not satisfied (No at S33), the other vehicle 200 returns to S33, and waits until the start condition is satisfied.

Upon determining that the start condition is satisfied (Yes at S33), the other vehicle 200 executes towed travel of the electric working vehicle 1 (S34). The other vehicle 200 determines whether an end instruction is input (S41), and upon determining that an end instruction is input (Yes at S41), ends the towed travel of the electric working vehicle 1. Upon determining that an end instruction is not input (No at S41), the other vehicle 200 returns to S41, and waits in the determination process until an end instruction is input.

Returning now to S31, when the mode information indicates PTO regeneration (“PTO regeneration” at S31), the other vehicle 200 provides a notification that the electric working vehicle 1 is in a PTO-regeneration-ready state (S35). The other vehicle 200 determines whether a start condition is satisfied (S36). As illustrated in FIG. 12, the other vehicle 200 determines that the start condition is satisfied when the parking brake is turned on, the output shaft 201 (PTO) of the other vehicle 200 is turned on (e.g., the number of revolutions is set to 600 rpm), and the travel of the other vehicle 200 is stopped (the shuttle lever of the other vehicle 200 is placed in the neutral position N) (Yes at S36). When the start condition is not satisfied (No at S36), the other vehicle 200 returns to S36, and waits until the start condition is satisfied.

Upon determining that the start condition is satisfied (Yes at S36), the other vehicle 200 executes forced drive of the PTO shaft 36 of the electric working vehicle 1 through drive of the output shaft 201 (PTO) of the other vehicle 200 (S37). The other vehicle 200 determines whether an end instruction is input (S42), and upon determining that an end instruction is input (Yes at S42), ends the forced drive of the PTO shaft 36 of the electric working vehicle 1. Upon determining that an end instruction is not input (No at S42), the other vehicle 200 returns to S42, and waits in the determination process until an end instruction is input.

Returning now to S31, when the mode information indicates towed/PTO regeneration (“towed/PTO regeneration” at S31), the other vehicle 200 provides a notification that the electric working vehicle 1 is in a towed/PTO-regeneration-ready state (S38). The other vehicle 200 determines whether a start condition is satisfied (S39). As illustrated in FIG. 12, the other vehicle 200 determines that the start condition is satisfied when the parking brake is turned off, the PTO is turned on (e.g., the number of revolutions is set to 600 rpm), and the other vehicle 200 is traveling forward (the shuttle lever of the other vehicle 200 is placed in the forward-travel position F) (Yes at S39). When the start condition is not satisfied (No at S39), the other vehicle 200 returns to S39, and waits until the start condition is satisfied.

Upon determining that the start condition is satisfied (Yes at S39), the other vehicle 200 executes towed travel of the electric working vehicle 1 and forced drive of the PTO shaft 36 (S40). The other vehicle 200 determines whether an end instruction is input (S43), and upon determining that an end instruction is input (Yes at S43), ends the towed travel of the electric working vehicle 1 and the forced drive of the PTO shaft 36. Upon determining that an end instruction is not input (No at S43), the other vehicle 200 returns to S43, and waits in the determination process until an end instruction is input.

The controller 101 may be configured or programmed to display a plurality of (three) regenerative modes on the selection screen M1 in FIG. 10A in order of decreasing efficiency of regenerative charging. For example, if the efficiency of regenerative charging is higher in the order of the towed and PTO regenerative mode, the PTO regenerative mode, and the towed regenerative mode, the controller 101 may simply display the modes in this order.

The controller 101 may be configured or programmed to, based on the position of the electric working vehicle 1 measured by the positioning device 105 and based on map information previously stored in the storage assembly 102, display at least one of pieces of information on the selection screen M1 in FIG. 10A including what priority is given to each of a plurality of (three) regenerative modes, and whether it is possible to execute these regenerative modes. For example, the controller 101 may be configured or programmed to, when there is no space around the electric working vehicle 1 where the electric working vehicle 1 can travel or when the electric working vehicle 1 is in a barn, display the PTO regenerative mode at a higher priority than other modes, and display an indication that it is not possible to execute the towed and PTO regenerative mode and the towed regenerative mode. The controller 101 may be configured or programmed to, when there is a space around the electric working vehicle 1 where the electric working vehicle 1 can travel, display the towed and PTO regenerative mode or the towed regenerative mode at a higher priority than the PTO regenerative mode.

The electric working vehicle 1 and the regenerative charging assistance system SY according to the example embodiments and the like described above include major characteristic items and achieve advantageous effects described below.
(Item A1) An electric working vehicle 1 including a battery 70, a traveling vehicle body 11 including the battery 70, wheels 22 provided at left and right sides of the traveling vehicle body 11, a first motor/generator 34 to drive the wheels 22 using electric power supplied from the battery 70, a second motor/generator 37 to drive, using electric power supplied from the battery 70, a PTO shaft 36 for connection with a working device 2, a motor controller 101c configured or programmed to control driving of the first motor/generator 34 and the second motor/generator 37, and an input interface 80 to receive input of an instruction to enter a regenerative mode in which at least one of the first motor/generator 34 or the second motor/generator 37 is driven regeneratively to charge the battery 70, wherein the regenerative mode includes a towed regenerative mode in which the traveling vehicle body 11 is towed to rotate the wheels 22 to regeneratively drive the first motor/generator 34, and a PTO regenerative mode in which the PTO shaft 36 is rotated by external power to regeneratively drive the second motor/generator 37, and the input interface 80 is configured to receive input of the instruction to enter the towed regenerative mode or the PTO regenerative mode.

With the above-mentioned configuration, the electric working vehicle 1 is configured to perform regenerative charging in a regenerative mode selected by the user from among a plurality of regenerative modes (e.g., the towed regenerative mode and the PTO regenerative mode). That is, the user can be provided with options of a plurality of types of regenerative charging for the electric working vehicle 1. This makes it possible to provide the electric working vehicle 1 configured to flexibly support a plurality of types of regenerative charging.
(Item 2) The electric working vehicle 1 according to item A1, wherein the regenerative mode further includes a towed and PTO regenerative mode in which the electric working vehicle operates concurrently in both the towed regenerative mode and the PTO regenerative mode.

With the configuration mentioned above, the electric working vehicle 1 is configured to perform regenerative charging in a plurality of regenerative modes, which are the following three regenerative modes the towed regenerative mode, the PTO regenerative mode, and the towed and PTO regenerative mode in which the electric working vehicle 1 operates concurrently in both the towed regenerative mode and the PTO regenerative mode. That is, the user can be provided with options of the three types of regenerative charging for the electric working vehicle 1. This makes it possible to provide the electric working vehicle 1 configured to further flexibly support a plurality of types of regenerative charging.
(Item A3) The electric working vehicle 1 according to item A1 or A2, wherein the motor controller 101c is configured or programmed to, when the electric working vehicle 1 is in the towed regenerative mode, control the driving of the first motor/generator 34 and the second motor/generator 37 such that the first motor/generator 34 is driven regeneratively and the second motor/generator 37 is stopped, and, when the electric working vehicle 1 is in the PTO regenerative mode, control the driving of the first motor/generator 34 and the second motor/generator 37 such that the first motor/generator 34 is stopped and the second motor/generator 37 is driven regeneratively.

With the above-mentioned configuration, the motor controller 101c is configured or programmed to, when the electric working vehicle 1 is in the towed regenerative mode, control the driving of the first motor/generator 34 and the second motor/generator 37 such that the first motor/generator 34 is driven regeneratively and the second motor/generator 37 is stopped. This makes it possible to eliminate or reduce the power otherwise consumed to drive the second motor/generator 37. Further, the motor controller 101c is configured or programmed to, when the electric working vehicle 1 is in the PTO regenerative mode, control the driving of the first motor/generator 34 and the second motor/generator 37 such that the first motor/generator 34 is stopped and the second motor/generator 37 is driven regeneratively. This makes it possible to eliminate or reduce the power otherwise consumed to drive the first motor/generator 34. This in turn makes it possible to perform efficient regenerative charging adapted to each regenerative mode.
(Item A4) The electric working vehicle 1 according to item A2, wherein the motor controller 101c is configured or programmed to, when the electric working vehicle 1 is in the towed and PTO regenerative mode, control the driving of the first motor/generator 34 and the second motor/generator 37 such that the first motor/generator 34 and the second motor/generator 37 are driven regeneratively.

With the above-mentioned configuration, the motor controller 101c is configured or programmed to, when the electric working vehicle 1 is in the towed and PTO regenerative mode, control the driving of the first motor/generator 34 and the second motor/generator 37 such that the first motor/generator 34 and the second motor/generator 37 are driven regeneratively. This makes it possible to perform regenerative charging via the first motor/generator 34 and the second motor/generator 37. This in turn makes it possible for the electric working vehicle 1 to perform efficient regenerative charging adapted to the towed and PTO regenerative mode.
(Item A5) The electric working vehicle 1 according to any one of items A1 to A4, further including a notifier 110 configured or programmed to, upon receipt by the input interface 80 of input of the instruction to enter the regenerative mode, provide a user with a notification prompting the user to change states of a travel operation actuator 57 and a working device operation actuator 58 to specified states based on the regenerative mode for which the instruction is received.

With the configuration mentioned above, in accordance with the notification provided by the notifier 110, the user is able to change the states of the travel operation actuator 57 and the working device operation actuator 58 to specified states based on the regenerative mode. This allows the user to easily bring each of the travel operation actuator 57 and the working device operation actuator 58 into a state suited to the regenerative mode. This in turn allows the user to perform a smooth transition of the electric working vehicle 1 into the regenerative mode.
(Item A6) The electric working vehicle 1 according to any one of items A1 to A5, further including a parking brake 56, wherein the travel operation actuator 57 includes a forward and rearward switching operation actuator 57A including a forward-travel position F, a rearward-travel position R, and a neutral position N and configured to be operated to switch a direction of travel of the traveling vehicle body 11, the working device operation actuator 58 includes a PTO switch 59, and the notifier 110 is configured or programmed to, when the regenerative mode is the towed regenerative mode, provide the notification to prompt the user to bring the forward and rearward switching operation actuator 57A into the forward-travel position F, turn off the parking brake 56, and turn off the PTO switch 59.

With the above-mentioned configuration, the notifier 110 is configured or programmed to, when the regenerative mode is the towed regenerative mode, provide the notification to prompt the user to bring the forward and rearward switching operation actuator 57A into the forward-travel position F, turn off the parking brake 56, and turn off the PTO switch 59. This allows the user to, in accordance with the notification provided by the notifier 110, easily bring each of the forward and rearward switching operation actuator 57A, the parking brake 56, and the PTO switch 59 into a state suited to the towed regenerative mode. This in turn allows the user to perform a smooth transition of the electric working vehicle 1 into the towed regenerative mode.
(Item A7) The electric working vehicle 1 according to any one of items A1 to A5, further including a parking brake 56, wherein the travel operation actuator 57 includes a forward and rearward switching operation actuator 557A including a forward-travel position F, a rearward-travel position R, and a neutral position N and configured to be operated to switch a direction of travel of the traveling vehicle body 11, the working device operation actuator 58 includes a PTO switch 59, and the notifier 110 is configured or programmed to, when the regenerative mode is the PTO regenerative mode, provide the notification to prompt the user to bring the forward and rearward switching operation actuator 557A into the neutral position N, turn on the parking brake 56, and turn on the PTO switch 59.

With the above-mentioned configuration, the notifier 110 is configured or programmed to, when the regenerative mode is the PTO regenerative mode, provide the notification to prompt the user to bring the forward and rearward switching operation actuator 57A into the neutral position N, turn on the parking brake 56, and turn on the PTO switch 59. This allows the user to, in accordance with the notification provided by the notifier 110, easily bring each of the forward and rearward switching operation actuator 57A, the parking brake 56, and the PTO switch 59 into a state suited to the PTO regenerative mode. This in turn allows the user to perform a smooth transition of the electric working vehicle 1 into the PTO regenerative mode.
(Item A8) The electric working vehicle 1 according to item A2 or A4, further including a parking brake 56, and a notifier 110 configured or programmed to, upon receipt by the input interface 80 of input of the instruction to enter the regenerative mode, provide a user with a notification to prompt the user to change states of a travel operation actuator 57 and a working device operation actuator 58 to specified states based on the regenerative mode for which the instruction is received, wherein the travel operation actuator 57 includes a forward and rearward switching operation actuator 57A including a forward-travel position F, a rearward-travel position R, and a neutral position N and configured to be operated to switch a direction of travel of the traveling vehicle body 11, the working device operation actuator 58 includes a PTO switch 59, and the notifier 110 is configured or programmed to, when the regenerative mode is the towed and PTO regenerative mode, provide the notification to prompt the user to bring the forward and rearward switching operation actuator 57A into the rearward-travel position R, turn off the parking brake 56, and turn on the PTO switch 59.

With the above-mentioned configuration, the notifier 110 is configured or programmed to, when the regenerative mode is the towed and PTO regenerative mode, provide the notification to prompt the user to bring the forward and rearward switching operation actuator 57A into the rearward-travel position R, turn off the parking brake 56, and turn on the PTO switch 59. This allows the user to, in accordance with the notification provided by the notifier 110, easily bring each of the forward and rearward switching operation actuator 57A, the parking brake 56, and the PTO switch 59 into a state suited to the towed and PTO regenerative mode. This in turn allows the user to perform a smooth transition of the electric working vehicle 1 into the towed and PTO regenerative mode.
(Item A9) The electric working vehicle 1 according to any one of items A1 to A8, further including a travel operation actuator 57, a working device operation actuator 58, and a parking brake 56, wherein the travel operation actuator 57 includes a forward and rearward switching operation actuator 57A including a forward-travel position F, a rearward-travel position R, and a neutral position N and configured to be operated to switch a direction of travel of the traveling vehicle body 11, the working device operation actuator 58 includes a PTO switch 59, and the motor controller 101c is configured or programmed to, upon receipt by the input interface 80 of input of the instruction to enter the towed regenerative mode, determine that a regeneration start condition is satisfied when the forward and rearward switching operation actuator 57A is in the forward-travel position F, the parking brake 56 is off, and the PTO switch 59 is off, and control the driving of the first motor/generator 34 and the second motor/generator 37 such that the first motor/generator 34 is driven regeneratively and the second motor/generator 37 is stopped.

With the above-mentioned configuration, the motor controller 101c is configured or programmed to start regenerative drive when a regeneration start condition for the towed regenerative mode is satisfied. This allows the electric working vehicle 1 to perform regenerative drive in the towed regenerative mode in a reliable and suitable manner.
(Item A10) The electric working vehicle 1 according to any one of items A1 to A8, further including a travel operation actuator 57, a working device operation actuator 58, and a parking brake 56, wherein the travel operation actuator 57 includes a forward and rearward switching operation actuator 57A including a forward-travel position F, a rearward-travel position R, and a neutral position N and configured to be operated to switch a direction of travel of the traveling vehicle body 11, the working device operation actuator 58 includes a PTO switch 59, and the motor controller 101c is configured or programmed to, upon receipt by the input interface 80 of input of the instruction to enter the PTO regenerative mode, determine that a regeneration start condition is satisfied when the forward and rearward switching operation actuator 57A is in the neutral position N, the parking brake 56 is on, and the PTO switch 59 is on, and control the driving of the first motor/generator 34 and the second motor/generator 37 such that the first motor/generator 34 is stopped and the second motor/generator 37 is driven regeneratively.

With the above-mentioned configuration, the motor controller 101c is configured or programmed to start regenerative drive when a regeneration start condition for the PTO regenerative mode is satisfied. This allows the electric working vehicle 1 to perform regenerative drive in the PTO regenerative mode in a reliable and suitable manner.
(Item A11) The electric working vehicle 1 according to item A2, A4, or A8, further including a travel operation actuator 57, a working device operation actuator 58, and a parking brake 56, wherein the travel operation actuator 57 includes a forward and rearward switching operation actuator 57A including a forward-travel position F, a rearward-travel position R, and a neutral position N and configured to be operated to switch a direction of travel of the traveling vehicle body 11, the working device operation actuator 58 includes a PTO switch 59, and the motor controller 101c is configured or programmed to, upon receipt by the input interface 80 of input of the instruction to enter the towed and PTO regenerative mode, determine that a regeneration start condition is satisfied when the forward and rearward switching operation actuator 57A is in the rearward-travel position R, the parking brake 56 is off, and the PTO switch 59 is on, and control the driving of the first motor/generator 34 and the second motor/generator 37 such that the first motor/generator 34 and the second motor/generator 37 are driven regeneratively.

With the above-mentioned configuration, the motor controller 101c is configured or programmed to start regenerative drive when a regeneration start condition for the towed and PTO regenerative mode is satisfied. This allows the electric working vehicle 1 to perform regenerative drive in the towed and PTO regenerative mode in a reliable and suitable manner.
(Item A12) The electric working vehicle 1 according to any one of items A1 to A11, further including a transmission 35 to change speed stages to change a propelling force for the traveling vehicle body 11, the transmission 35 being configured to switch at least between a first speed stage including a first speed and a second speed stage including a second speed which is greater than the first speed, and a transmission controller 101e configured or programmed to control the transmission 35, wherein the transmission controller 101e is configured or programmed to bring the transmission 35 into the first speed stage when the electric working vehicle 1 is in the towed regenerative mode.

With the above-mentioned configuration, the transmission 35 is brought into the first speed stage when the electric working vehicle 1 is in the towed regenerative mode. As a result, the number of revolutions of the first motor/generator 34 (the number of revolutions of the first motor/generator 34 per revolution of the wheels 22) due to the regenerative drive can be made higher than that when the transmission 35 is in the second speed stage. This makes it possible to improve the efficiency of charging performed through regenerative drive. The above-mentioned configuration of the electric working vehicle 1 therefore makes it possible to improve the efficiency of charging performed through regenerative drive in the towed regenerative mode.
(Item A13) The electric working vehicle 1 according to item A2, A4, A8, or A11, further including a transmission 35 to change speed stages to change a propelling force for the traveling vehicle body 11, the transmission 35 being configured to switch at least between a first speed stage including a first speed and a second speed stage including a second speed which is greater than the first speed, and a transmission controller 101e configured or programmed to control the transmission 35, wherein the transmission controller 101e is configured or programmed to bring the transmission 35 into the first speed stage when the electric working vehicle 1 is in the towed and PTO regenerative mode.

With the above-mentioned configuration, the transmission 35 is brought into the first speed stage when the electric working vehicle 1 is in the towed and PTO regenerative mode. As a result, the number of revolutions of the first motor/generator 34 (the number of revolutions of the first motor/generator 34 per revolution of the wheels 22) due to the regenerative drive can be made higher than that when the transmission 35 is in the second speed stage. This makes it possible to improve the efficiency of charging performed through regenerative drive. The above-mentioned configuration of the electric working vehicle 1 therefore makes it possible to improve the efficiency of charging performed through regenerative drive in the towed and PTO regenerative mode.
(Item A14) A regenerative charging assistance system SY including the electric working vehicle 1 according to item A1, and another vehicle 200 including an output shaft 201 to couple the PTO shaft 36 thereto and configured to tow the electric working vehicle 1, wherein the towed regenerative mode is a regenerative mode in which the another vehicle 200 tows the traveling vehicle body 11 to rotate the wheels 22 to regeneratively drive the first motor/generator 34, and the PTO regenerative mode is a regenerative mode in which, when the PTO shaft 36 is in connection with the output shaft 201 of the another vehicle 200, power from the output shaft 201 rotates the PTO shaft 36 to regeneratively drive the second motor/generator 37.

With the above-mentioned configuration, the regenerative charging assistance system SY allows the other vehicle 200 to be brought into a state suited to regenerative charging of the electric working vehicle 1, and thus allows the electric working vehicle 1 to be charged regeneratively in a regenerative mode selected by the user from among a plurality of regenerative modes (e.g., the towed regenerative mode and the PTO regenerative mode). That is, the user can be provided with options of a plurality of types of regenerative charging for the electric working vehicle 1. The above-mentioned configuration of the regenerative charging assistance system SY therefore makes it possible to provide the electric working vehicle 1 configured to flexibly support a plurality of types of regenerative charging.

While example embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An electric working vehicle comprising:
a battery;
a traveling vehicle body including the battery;
wheels provided at left and right sides of the traveling vehicle body;
a first motor/generator to drive the wheels using electric power supplied from the battery;
a second motor/generator to drive, using electric power supplied from the battery, a power take-off (PTO) shaft for connection with a working device;
a motor controller configured or programmed to control driving of the first motor/generator and the second motor/generator; and
an input interface to receive input of an instruction to enter a regenerative mode in which at least one of the first motor/generator or the second motor/generator is driven regeneratively to charge the battery; wherein
the regenerative mode includes a towed regenerative mode in which the traveling vehicle body is towed to rotate the wheels to regeneratively drive the first motor/generator, and a PTO regenerative mode in which the PTO shaft is rotated by external power to regeneratively drive the second motor/generator; and
the input interface is configured to receive input of the instruction to enter the towed regenerative mode or the PTO regenerative mode.

2. The electric working vehicle according to claim 1, wherein the regenerative mode further includes a towed and PTO regenerative mode in which the electric working vehicle operates concurrently in both the towed regenerative mode and the PTO regenerative mode.

3. The electric working vehicle according to claim 1, wherein the motor controller is configured or programmed to, when the electric working vehicle is in the towed regenerative mode, control the driving of the first motor/generator and the second motor/generator such that the first motor/generator is driven regeneratively and the second motor/generator is stopped, and, when the electric working vehicle is in the PTO regenerative mode, control the driving of the first motor/generator and the second motor/generator such that the first motor/generator is stopped and the second motor/generator is driven regeneratively.

4. The electric working vehicle according to claim 2, wherein the motor controller is configured or programmed to, when the electric working vehicle is in the towed and PTO regenerative mode, control the driving of the first motor/generator and the second motor/generator such that the first motor/generator and the second motor/generator are driven regeneratively.

5. The electric working vehicle according to claim 1, further comprising a notifier configured or programmed to, upon receipt by the input interface of input of the instruction to enter the regenerative mode, provide a user with a notification prompting the user to change states of a travel operation actuator and a working device operation actuator to specified states based on the regenerative mode for which the instruction is received.

6. The electric working vehicle according to claim 5, further comprising a parking brake; wherein
the travel operation actuator includes a forward and rearward switching operation actuator including a forward-travel position, a rearward-travel position, and a neutral position and configured to be operated to switch a direction of travel of the traveling vehicle body;
the working device operation actuator includes a PTO switch; and
the notifier is configured or programmed to, when the regenerative mode is the towed regenerative mode, provide the notification to prompt the user to bring the forward and rearward switching operation actuator into the forward-travel position, turn off the parking brake, and turn off the PTO switch.

7. The electric working vehicle according to claim 5, further comprising a parking brake; wherein
the travel operation actuator includes a forward and rearward switching operation actuator including a forward-travel position, a rearward-travel position, and a neutral position and configured to be operated to switch a direction of travel of the traveling vehicle body;
the working device operation actuator includes a PTO switch; and
the notifier is configured or programmed to, when the regenerative mode is the PTO regenerative mode, provide the notification to prompt the user to bring the forward and rearward switching operation actuator into the neutral position, turn on the parking brake, and turn on the PTO switch.

8. The electric working vehicle according to claim 2, further comprising:
a parking brake; and
a notifier configured or programmed to, upon receipt by the input interface of input of the instruction to enter the regenerative mode, provide a user with a notification to prompt the user to change states of a travel operation actuator and a working device operation actuator to specified states based on the regenerative mode for which the instruction is received; wherein
the travel operation actuator includes a forward and rearward switching operation actuator including a forward-travel position, a rearward-travel position, and a neutral position and configured to be operated to switch a direction of travel of the traveling vehicle body;
the working device operation actuator includes a PTO switch; and
the notifier is configured or programmed to, when the regenerative mode is the towed and PTO regenerative mode, provide the notification to prompt the user to bring the forward and rearward switching operation actuator into the rearward-travel position, turn off the parking brake, and turn on the PTO switch.

9. The electric working vehicle according to claim 1, further comprising:
a travel operation actuator;
a working device operation actuator; and
a parking brake; wherein
the travel operation actuator includes a forward and rearward switching operation actuator including a forward-travel position, a rearward-travel position, and a neutral position and configured to be operated to switch a direction of travel of the traveling vehicle body;
the working device operation actuator includes a PTO switch; and
the motor controller is configured or programmed to, upon receipt by the input interface of input of the instruction to enter the towed regenerative mode:
determine that a regeneration start condition is satisfied when the forward and rearward switching operation actuator is in the forward-travel position, the parking brake is off, and the PTO switch is off; and
control the driving of the first motor/generator and the second motor/generator such that the first motor/generator is driven regeneratively and the second motor/generator is stopped.

10. The electric working vehicle according to claim 1, further comprising:
a travel operation actuator;
a working device operation actuator; and
a parking brake; wherein
the travel operation actuator includes a forward and rearward switching operation actuator including a forward-travel position, a rearward-travel position, and a neutral position and configured to be operated to switch a direction of travel of the traveling vehicle body;
the working device operation actuator includes a PTO switch; and
the motor controller is configured or programmed to, upon receipt by the input interface of input of the instruction to enter the PTO regenerative mode:
determine that a regeneration start condition is satisfied when the forward and rearward switching operation actuator is in the neutral position, the parking brake is on, and the PTO switch is on; and
control the driving of the first motor/generator and the second motor/generator such that the first motor/generator is stopped and the second motor/generator is driven regeneratively.

11. The electric working vehicle according to claim 2, further comprising:
a travel operation actuator;
a working device operation actuator; and
a parking brake; wherein
the travel operation actuator includes a forward and rearward switching operation actuator including a forward-travel position, a rearward-travel position, and a neutral position and configured to be operated to switch a direction of travel of the traveling vehicle body;
the working device operation actuator includes a PTO switch; and
the motor controller is configured or programmed to, upon receipt by the input interface of input of the instruction to enter the towed and PTO regenerative mode:
determine that a regeneration start condition is satisfied when the forward and rearward switching operation actuator is in the rearward-travel position, the parking brake is off, and the PTO switch is on; and
control the driving of the first motor/generator and the second motor/generator such that the first motor/generator and the second motor/generator are driven regeneratively.

12. The electric working vehicle according to claim 1, further comprising:
a transmission to change speed stages to change a propelling force for the traveling vehicle body, the transmission being configured to switch at least between a first speed stage including a first speed and a second speed stage including a second speed which is greater than the first speed; and
a transmission controller configured or programmed to control the transmission; wherein
the transmission controller is configured or programmed to bring the transmission into the first speed stage when the electric working vehicle is in the towed regenerative mode.

13. The electric working vehicle according to claim 2, further comprising:
a transmission to change speed stages to change a propelling force for the traveling vehicle body, the transmission being configured to switch at least between a first speed stage including a first speed and a second speed stage including a second speed which is greater than the first speed; and
a transmission controller configured or programmed to control the transmission; wherein
the transmission controller is configured or programmed to bring the transmission into the first speed stage when the electric working vehicle is in the towed and PTO regenerative mode.

14. A regenerative charging assistance system comprising:
the electric working vehicle according to claim 1; and
another vehicle including an output shaft to couple the PTO shaft thereto and configured to tow the electric working vehicle; wherein
the towed regenerative mode is a regenerative mode in which the another vehicle tows the traveling vehicle body to rotate the wheels to regeneratively drive the first motor/generator; and
the PTO regenerative mode is a regenerative mode in which, when the PTO shaft is in connection with the output shaft of the another vehicle, power from the output shaft rotates the PTO shaft to regeneratively drive the second motor/generator.
